(19) United States
(12) Patent Application Publication
(10) Pub. No.: US 2025/0063523 A1
(43) Pub. Date: Feb. 20, 2025

(54) MULTIPLE TIMING ADVANCES FOR MULTIPLE TRANSMISSION RECEPTION POINTS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/721,267

(22) PCT Filed: Feb. 11, 2022
(86) PCT No.: PCT/CN2022/075986

§ 371 Date: Jun. 18, 2024

(51) Int. Cl. H04W 56/00

(52) U.S. Cl. CPC H04W 56/0045

(57) ABSTRACT

An apparatus equipped with multiple antenna panels for wireless communication is provided. The apparatus receives a configuration message including a serving cell configuration and a bandwidth part configuration, wherein the serving cell configuration includes first timing advance information for a component carrier, and wherein the bandwidth part configuration includes second timing advance information for a bandwidth part of the component carrier. The apparatus transmits a first uplink signal (e.g., via a first antenna panel) to a first transmission reception point (TRP) using the bandwidth part based on at least a first timing advance value associated with the first timing advance information. The apparatus transmits a second uplink signal (e.g., via a second antenna panel) to a second TRP using the bandwidth part based on at least a second timing advance value associated with the second timing advance information.

### BACKGROUND

### Technical Field

The present disclosure relates generally to communication systems, and more particularly, to multiple timing advances for multiple transmission reception points (TRPs).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) may apply a timing advance to uplink transmissions to a transmission reception point (TRP) to compensate for propagation delays between the UE and the TRP. However, if the UE can concurrently communicate with multiple TRPs (e.g., multi-TRP operation) using a component carrier, the UE may need to apply different timing advances to uplink transmissions to the multiple TRPs. The aspects described herein include timing advance configurations for a UE for multi-TRP operation.

In an aspect of the disclosure, a method, a computer-readable medium, and an apparatus are provided. The apparatus may be a UE. The UE receives a configuration message including a serving cell configuration and a bandwidth part configuration, wherein the serving cell configuration includes first timing advance information for a component carrier, and wherein the bandwidth part configuration includes second timing advance information for a bandwidth part of the component carrier. The UE transmits a first uplink signal to a first TRP using the bandwidth part based on at least a first timing advance value associated with the first timing advance information. The UE transmits a second uplink signal to a second TRP using the bandwidth part based on at least a second timing advance value associated with the second timing advance information.

In an aspect of the disclosure, a method, a computer-readable medium, and an apparatus are provided. The apparatus may be a UE. The UE receives a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier. The UE transmits a first uplink signal to a first TRP using the bandwidth part based on a first timing advance value associated with the first timing advance information and a second timing advance value associated with the second timing advance information. The UE transmits a second uplink signal to a second TRP using the bandwidth part based on the first timing advance value associated with the first timing advance information and a third timing advance value associated with the third timing advance information.

In an aspect of the disclosure, a method, a computer-readable medium, and an apparatus are provided. The apparatus may be a TRP as described herein. The apparatus transmits a configuration message including a serving cell configuration and a bandwidth part configuration, wherein the serving cell configuration includes first timing advance information for a component carrier, and wherein the bandwidth part configuration includes second timing advance information for a bandwidth part of the component carrier. The apparatus transmits a first timing advance command including a first timing advance value associated with the first timing advance information. The apparatus transmits a second timing advance command including a second timing advance value associated with the second timing advance information.

In some aspects, the first timing advance information includes a first timing advance group identifier, the first timing advance command including the first timing advance group identifier, the second timing advance information includes a second timing advance group identifier, the second timing advance command including the second timing advance group identifier.

In some aspects, the bandwidth part configuration enables multi-TRP operation for the bandwidth part.

In some aspects, the bandwidth part is one of a plurality of bandwidth parts associated with the component carrier, and wherein the second timing advance information for the bandwidth part is not associated with one or more different bandwidth parts of the plurality of bandwidth parts.

In some aspects, the one or more different bandwidth parts of the plurality of bandwidth parts are configured for single TRP operation.

In some aspects, the first timing advance information includes a timing advance group identifier, the first timing advance command including the timing advance group identifier, and wherein the second timing advance information includes a timing advance offset identifier, the second timing advance command including the timing advance offset identifier.

In an aspect of the disclosure, a method, a computer-readable medium, and an apparatus are provided. The apparatus may be a TRP as described herein. The apparatus transmits a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier. The apparatus transmits a first timing advance command including a first timing advance value associated with the first timing advance information. The apparatus transmits a second timing advance command including a second timing advance value associated with the second timing advance information. The apparatus transmits a third timing advance command including a third timing advance value associated with the third timing advance information.

In some aspects, a timing advance group identifier is included in the first timing advance information and the first timing advance command, a first timing advance offset identifier is included in the second timing advance information and the second timing advance command, and a second timing advance offset identifier is included in the third timing advance information and the third timing advance command.

In some aspects, the bandwidth part configuration enables multi-TRP operation for the bandwidth part.

In some aspects, the bandwidth part is one of a plurality of bandwidth parts associated with the component carrier, and wherein the second timing advance information and the third timing advance information for the bandwidth part is not associated with one or more different bandwidth parts of the plurality of bandwidth parts.

In some aspects, the one or more different bandwidth parts of the plurality of bandwidth parts are configured for single TRP operation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a transmission reception point (TRP) and user equipment (UE) in an access network.

FIG. 4 illustrates a wireless communication network including a UE and a base station.

FIG. 5 illustrates an example timing diagram.

FIG. 6 illustrates example bandwidth parts (BWPs) of a carrier bandwidth configured for a UE.

FIG. 7 illustrates a wireless communication network including a UE, a first transmission reception point (TRP), and a second TRP.

FIG. 8 shows an example timing diagram for DL and UL transmissions in a wireless communication network.

FIG. 9 illustrates an example timing advance configuration diagram.

FIG. 10 illustrates a configuration diagram for a first example timing advance configuration in accordance with various aspects of the disclosure.

FIG. 11 is a signal flow diagram in accordance with various aspects of the disclosure.

FIG. 12 illustrates an example timing advance command medium access control (MAC) control element (MAC-CE) for indicating a timing advance command to a UE.

FIG. 13 shows an example timing diagram for the signal flow diagram in FIG. 11.

FIG. 14 illustrates a configuration diagram for a second example timing advance configuration in accordance with various aspects of the disclosure.

FIG. 15 is a signal flow diagram in accordance with various aspects of the disclosure.

FIG. 16 illustrates an example timing advance command MAC-CE for indicating a timing advance offset to a UE.

FIG. 17 shows an example timing diagram for the signal flow diagram in FIG. 15.

FIG. 18 illustrates a configuration diagram for a third example timing advance configuration in accordance with various aspects of the disclosure.

FIG. 19 is a signal flow diagram in accordance with various aspects of the disclosure.

FIG. 20 shows an example timing diagram for the signal flow diagram in FIG. 19.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a conceptual data flow diagram illustrating the data flow between different means/components in an example apparatus.

FIG. 27 is a diagram illustrating an example of a hardware implementation for an apparatus employing a processing system.

FIG. 28 is a flowchart of a method of wireless communication.

FIG. 29 is a flowchart of a method of wireless communication.

FIG. 30 is a conceptual data flow diagram illustrating the data flow between different means/components in an example apparatus.

FIG. 31 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

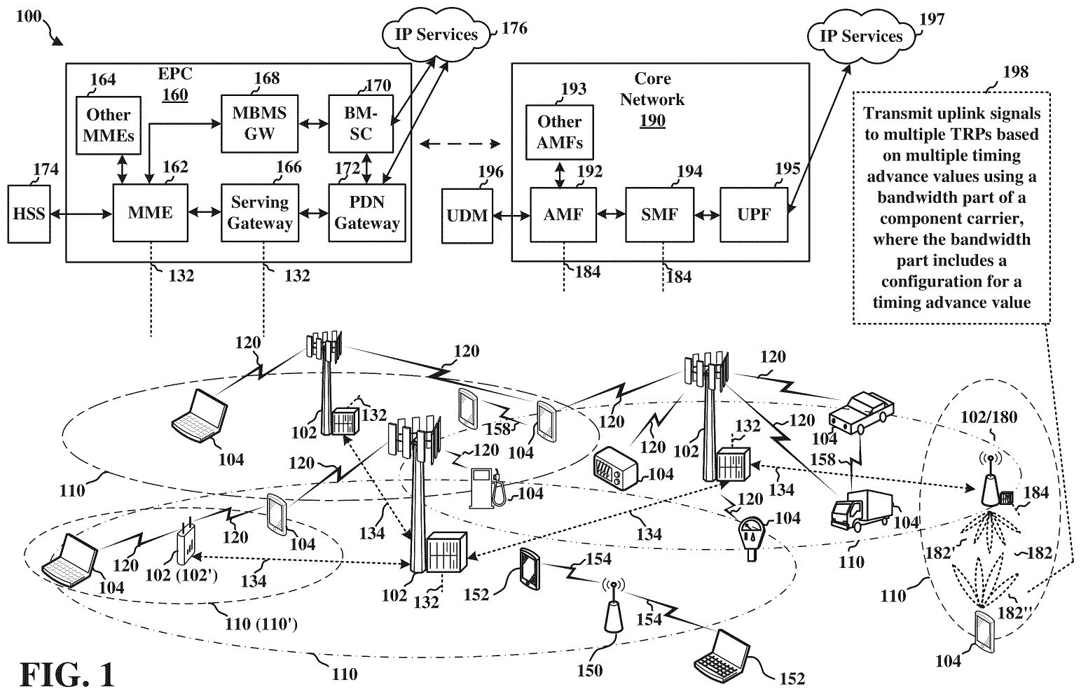

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to transmit uplink signals to multiple transmission reception points (TRPs) based on multiple timing advance values using a bandwidth part of a component carrier, where the bandwidth part includes a configuration for a timing advance value. Although the following description may be focused on 5G NR, the concepts described herein may be applicable to other similar areas, such as LTE, LTE-A, CDMA, GSM, and other wireless technologies.

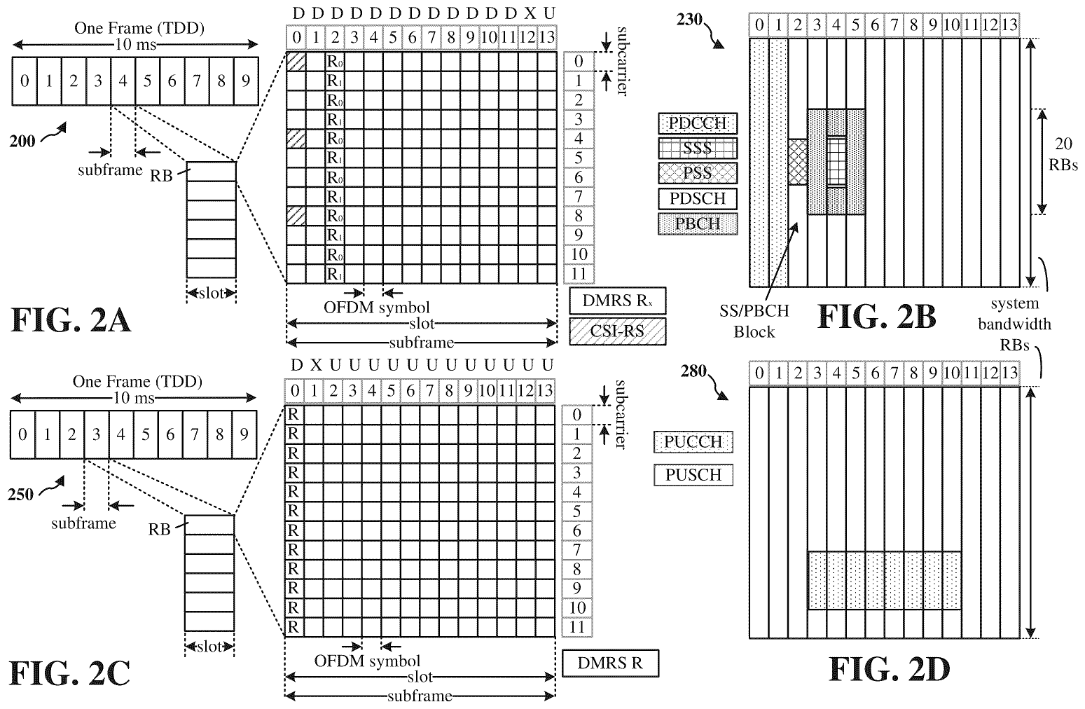

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies u 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

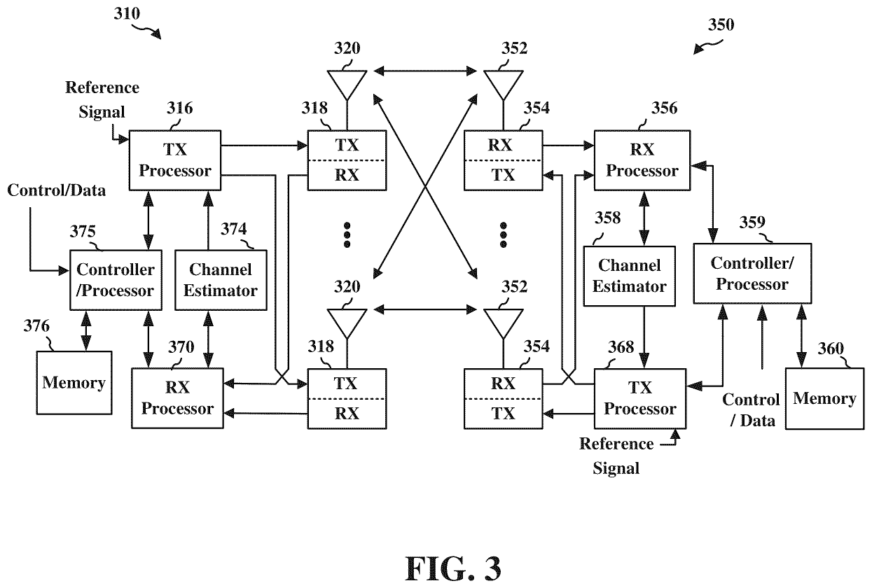

FIG. 3 is a block diagram of a base station 310 in communication with a UE 350 in an access network. In some implementations, the base station 310 may serve as a transmission reception point (TRP). In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

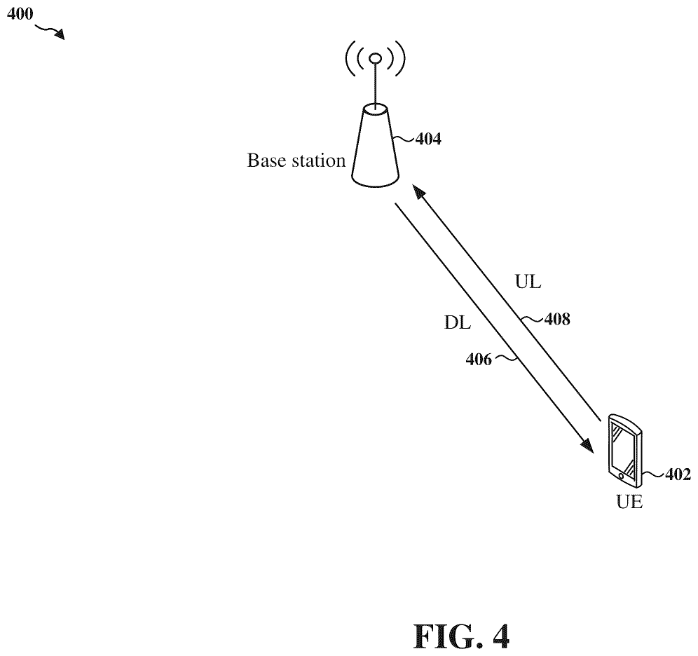

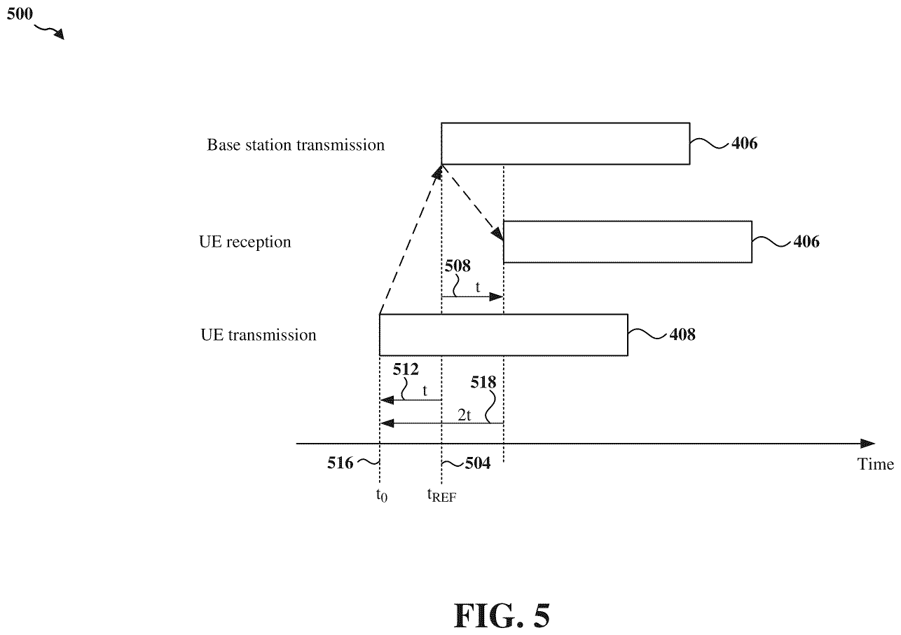

FIG. 4 illustrates a wireless communication network 400 including a user equipment (UE) 402 and a base station 404. As shown in FIG. 4, the base station 404 may transmit a downlink (DL) signal 406 (also referred to as a DL transmission) to the UE 402, and the UE 402 may transmit an uplink (UL) signal 408 (also referred to as a UL transmission) to the base station 404. The downlink signal 406 and the uplink signal 408 may experience propagation delays, which may cause timing misalignments between the UE 402 and the base station 404. These timing misalignments may significantly degrade the performance of the UE 402. To compensate for the propagation delays, the UE 402 may apply a timing advance to uplink transmissions. This is explained in greater detail with reference to FIG. 5.

FIG. 5 illustrates an example timing diagram for the previously described wireless communication network 400. As shown in FIG. 5, the base station 404 may transmit the downlink signal 406 at time t_{REF} 504. The downlink signal 406 may arrive at the UE 402 after a period t 508 due to a propagation delay. For example, t may represent a time value expressed in a suitable unit of time, such as milliseconds (ms) or microseconds (μs). To avoid timing misalignments, the UE 402 may transmit the uplink signal 408 earlier (e.g., a time period t 512 before the time t_{REF} 504) to compensate for the propagation delay. For example, with reference to FIG. 5, the UE 502 may transmit the uplink signal 408 at time to 516 to allow the uplink signal 408 to arrive time-aligned at the base station 404 at time t_{REF} 504. In some examples, the difference between the time t_{REF} 504 and the time to 516 may be approximately equal to the propagation delay between the UE 402 and the base station 404.

In 5G NR, a base station may transmit a timing advance (TA) command to a UE to adjust the timing of uplink transmissions from a UE. For example, the TA command may indicate a timing offset (also referred to as a timing advance value) that the UE may apply to uplink transmissions, such as the timing offset 518 approximately equal to a period 2t. This timing offset may ensure that uplink transmissions from a UE are time aligned with a reference time at the network side (e.g., at a base station, TRP, etc.). For example, if the reference time at a base station or TRP is a beginning of an uplink subframe, the timing advance command may control (e.g., with a timing offset) when the UE performs an uplink transmission so that the uplink transmission arrives at the base station time aligned with the beginning of the uplink subframe.

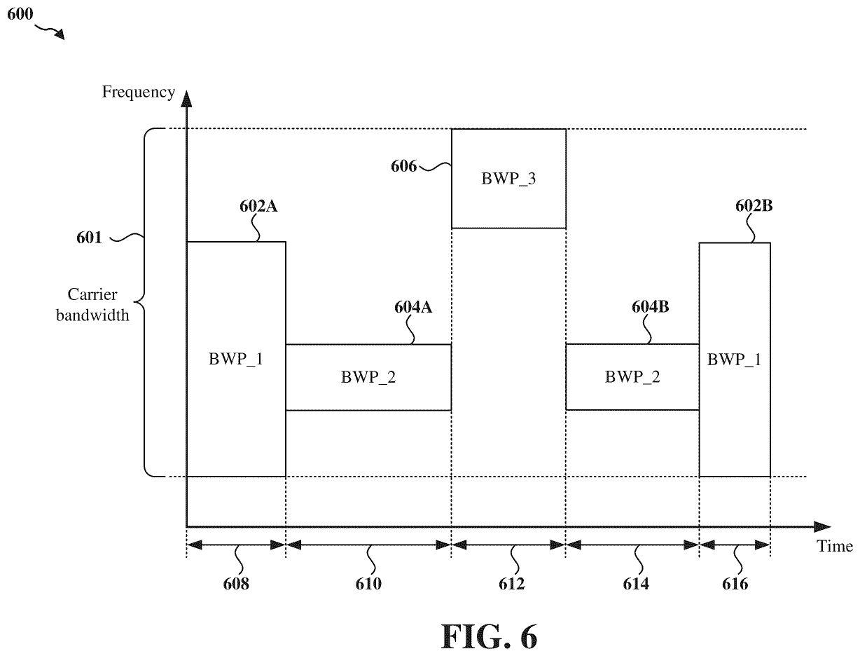

FIG. 6 illustrates example bandwidth parts (BWPs) of a carrier bandwidth 601 configured for a UE. As shown in FIG. 6, a first bandwidth part (BWP_1) 602A may be configured for the UE during a first time period 608, a second bandwidth part (BWP_2) 604A may be configured for the UE during a second time period 610, and a third bandwidth part (BWP_3) 606 may be configured for the UE during a third time period 612. In the example scenario shown in FIG. 6, the second bandwidth part (BWP_2) 604B may be configured for the UE during a fourth time period 614 and the first bandwidth part (BWP_1) 602B may be configured for the UE during a fifth time period 616. In some examples, the first bandwidth part (BWP_1) 602A, 602B may be 40 MHz, the second bandwidth part (BWP_2) 604A, 604B may be 10 MHz, and the third bandwidth part (BWP_3) 606 may be 20 MHz. In some examples, the first bandwidth part (BWP_1) 602A, 602B and the second bandwidth part (BWP_2) 604A, 604B may have a subcarrier spacing of 15 kHz, and the third bandwidth part (BWP_3) 606 may have a subcarrier spacing of 60 kHz. In some examples, the carrier bandwidth 601 may represent the bandwidth of a component carrier in cases where the UE supports carrier aggregation.

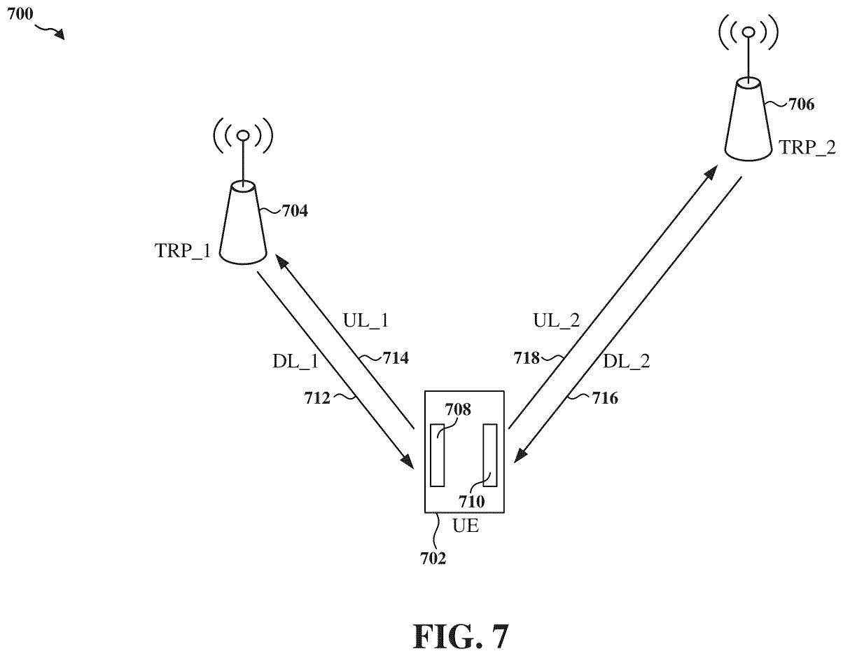

FIG. 7 illustrates a wireless communication network 700 including a UE 702, a first transmission reception point (TRP_1) 704, and a second transmission reception point (TRP_2) 706. In some aspects, the UE 702 may include multiple antenna panels, such as a first antenna panel 708 and a second antenna panel 710. The UE 702 may receive a DL signal from a TRP, and transmit a UL signal to a TRP. In some examples, the association between a DL signal or a UL signal and a TRP may be predetermined based on a rule. In other examples, the association between a DL signal or a UL signal and a TRP may be based on an indication provided to the UE 702, a configuration of the UE 702, or a combination thereof.

As shown in FIG. 7, the TRP_1 704 may transmit a first DL signal 712 (labeled as DL_1 in FIG. 7) to the UE 702, and the UE 402 may transmit a first UL signal 714 (labeled as UL_1 in FIG. 7) to the TRP_1 704. In some examples, the TRP_1 704 may transmit the first DL signal 712 in a first downlink control channel (e.g., PDCCH_1) and the UE 702 may transmit the first UL signal 714 in a first uplink data channel (e.g., PUSCH_1). The UE 702 may use the first antenna panel 708 to receive the first DL signal 712 and to transmit the first UL signal 714.

In some examples, the TRP_2 706 may transmit a second DL signal 716 (labeled as DL_2 in FIG. 7) to the UE 702, and the UE 402 may transmit a second UL signal 718 (labeled as UL_2 in FIG. 7) to the TRP_2 706. In some examples, the TRP_2 706 may transmit the second DL signal 716 in a second downlink control channel (e.g., PDCCH_2) and the UE 702 may transmit the second UL signal 718 in a second uplink data channel (e.g., PUSCH_2). The UE 702 may use the second antenna panel 710 to receive the second DL signal 716 and to transmit the second UL signal 718. The first and second DL signals 712, 716 may be referred to as DL transmissions and the first and second UL signals 714, 718 may be referred to as UL transmissions.

The UE 702 may use multiple antenna panels (e.g., the first and second antenna panels 708, 710) to communicate concurrently with two or more TRPs (e.g., TRP_1 704, TRP_2 706). The concurrent communication between the UE 702 and multiple TRPs (e.g., TRP_1 704, TRP_2 706) may be referred to as multi-TRP or mTRP operation.

In some examples, the first antenna panel 708 may apply a first transmission configuration indicator (TCI) state and a first QCL type when communicating with the TRP_1 704 via the first antenna panel 708. The second antenna panel 710 may apply a second TCI state and a second QCL type when communicating with the TRP_2 706 via the second antenna panel 710. Power control for the first and second UL signals 714, 716 may be based on UL single DCI for multi-TRP operation.

The first and second DL signals 712, 716 and the first and second UL signals 714, 718 may experience propagation delays, which may cause timing misalignments between the UE 702 and each of the first and second TRPs 704, 706. These timing misalignments may degrade the performance of the UE 702 and/or the first and second TRPs 704, 706. To compensate for the propagation delays, the UE 702 may apply different timing advances to different uplink transmissions (e.g., the first and second UL signals 714, 718).

A TRP may transmit a timing advance (TA) command to a UE to adjust the timing of uplink transmissions from a UE. For example, the TA command may indicate a timing advance that the UE may apply to uplink transmissions. This timing advance may ensure that uplink transmissions from a UE are time aligned with a reference time at the network side (e.g., at a base station and/or a TRP). For example, if the reference time at a TRP is a beginning of an uplink subframe, the timing advance command may control (e.g., with a timing advance value in the timing advance command) when the UE performs an uplink transmission so that the uplink transmission arrives at the TRP time aligned with the beginning of the uplink subframe.

A UE may receive a configuration for a serving cell in an information element (IE) (herein referred to as a ServingCellConfig IE). For example, a ServingCellConfig IE may include a parameter (herein referred to as tag-id) for indicating a timing advance group (TAG), a parameter (herein referred to as downlinkBWP-ToReleaseList) for indicating a list of downlink BWP configurations to be released (e.g., removed), and a parameter (herein referred to as downlinkBWP-ToAddModList) for indicating a list of downlink BWP configurations to be added. The downlinkBWP-ToAddModList parameter may indicate that multiple BWPs are configured for a UE.

In some examples, the tag-Id may indicate a timing advance group (TAG) to which the serving cell belongs. A TAG may include one or more serving cells that share the same timing. For example, a UE may apply the same timing advance value to serving cells belonging to the same TAG. An example structure of a ServingCellConfig IE may be represented using the Abstract Syntax Notation One (ASN.1) code as follows:

```
ServingCellConfig ::= SEQUENCE {
  ...
  tag-Id, TAG-Id
  downlinkBWP-ToReleaseList
  downlinkBWP-ToAddModList
  ...
}.
```

Each BWP of a serving cell may be configured using an IE, where the BWP may be configured for downlink or uplink. For example, a BWP-DownlinkDedicated IE may include dedicated (e.g., UE specific) parameters of a downlink BWP. In some examples, each BWP-DownlinkDedicated IE may include an IE containing a configuration for a control channel (herein referred to as a pdcch-Config IE). In some examples, the control channel may be a PDCCH. For example, the configuration for the control channel for the UE may include a radio resource control (RRC) configuration. An example structure of a BWP-DownlinkDedicated IE may be represented using the ASN.1 code as follows:

```
BWP-DownlinkDedicated ::= SEQUENCE {
  pdcch-Config
  ...
}.
```

The pdcch-Config IE may configure multiple control resource sets (CORESETs) for the control channel (e.g., for a PDCCH) using an IE herein referred to as a controlResourceSetToAddModList IE. In some examples, the controlResourceSetToAddModList IE may contain a list of UE specific CORESETs to be used by the UE for a BWP. In some examples, up to five CORESETs may be configured per BWP per cell (including an initial CORESET). The pdcch-Config IE may further include an IE herein referred to as a controlResourceSetToReleaseList IE, which may indicate a list of CORESETs to be released (e.g., removed) for a BWP. An example structure of a pdcch-Config IE may be represented using the ASN.1 code as follows:

```
PDCCH-Config ::= SEQUENCE {
  controlResourceSetToAddModList
  controlResourceSetToReleaseList
  ...
}.
```

A CORESET may be configured using an IE herein referred to as a ControlResourceSet IE. The ControlResourceSet IE may indicate a CORESET pool index value for the CORESET using a parameter herein referred to as coresetPoolIndex. The coresetPoolIndex parameter may be set to one of two values (e.g., either 0 or 1). In some examples, the coresetPoolIndex parameter may be used to support multiple DCI based multiple TRPs, where DCIs in CORESETs of different CORESET pool indexes may schedule a DL or UL signal associated with different TRPs. For example, a first value (e.g., 0) for the coresetPoolIndex parameter may be associated with a first TRP in the downlink, and a second value (e.g., 1) for the coresetPoolIndex parameter may be associated with a second TRP in the downlink. The ControlResourceSet IE may further indicate a CORESET identifier for the CORESET using a parameter herein referred to as controlResourceSetId. An example structure of a ControlResourceSet IE may be represented using the ASN.1 code as follows:

```
ControlResourceSet ::= SEQUENCE {
  coresetPoolIndex INTEGER (0 .. 1)
  controlResourceSetId
  ...
}.
```

A timing advance configuration may apply to multiple cells (e.g., multiple component carriers) and may be common across the BWPs of each cell (e.g., each component carrier). For example, a timing advance configuration for a serving cell may apply to all BWPs of that serving cell. An mTRP configuration (e.g., a configuration for multiple TRPs where different CORESET pool index values are configured), however, may be specific to each BWP of each component carrier.

In some scenarios, a serving cell may be configured with multiple BWPs and one of the multiple BWPs may be configured for mTRP operation. For example, with reference to FIG. 7, the UE 702 may use a BWP configured for mTRP operation to communicate with the first TRP 704 and the second TRP 706. In these scenarios, the UE 702 may need to apply different timing advance values when transmitting UL signals to the first TRP 704 and the second TRP 706 using the BWP configured for mTRP. It should be understood that if a BWP is not configured for mTRP operation (e.g., if the BWP is configured for single TRP operation), a UE may not be able to use the BWP to communicate with multiple TRPs.

In one example, multiple timing advance values may be configured for a component carrier allocated to a UE to enable multiple DCI (mDCI) mTRP operation. For example, each serving cell may be configured with multiple timing advance group identifiers (Tag-Ids), where each Tag-Id is associated with a different TRP. In these examples, a BWP of a component carrier may be configured for mDCI mTRP operation.

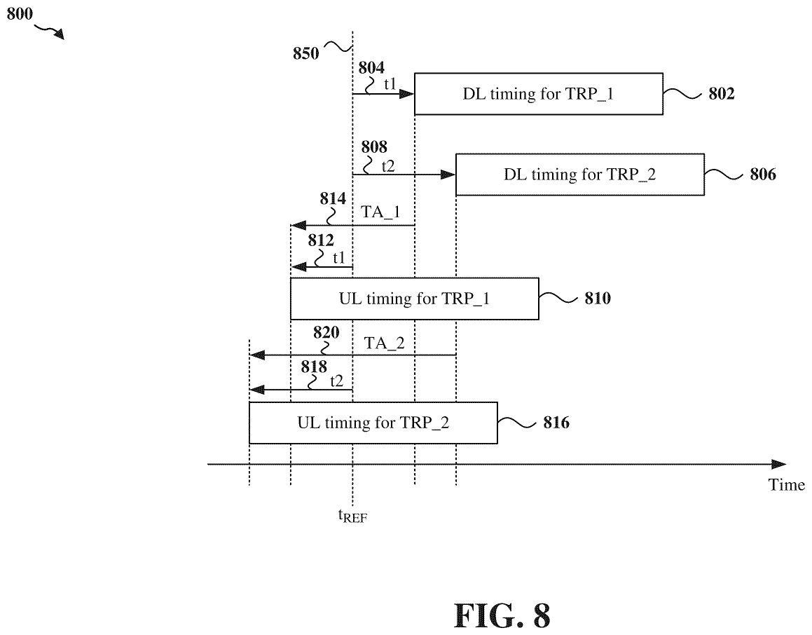

FIG. 8 shows an example timing diagram 800 for DL and UL transmissions in the wireless communication network 700. The timing diagram 800 includes a DL timing 802 for TRP_1 704, a DL timing 806 for TRP_2 706, a UL timing 810 for TRP_1 704, and a UL timing 816 for TRP_2 706. The DL timing 802 shows the propagation delay t1 804 for a first DL transmission (e.g., the first DL signal 712) transmitted at a time t_{REF} 850. For example, t1 may represent a time value expressed in a suitable unit of time, such as milliseconds or microseconds. The DL timing 806 shows the propagation delay t2 808 for a second DL transmission (e.g., the second DL signal 716) transmitted at a time t_{REF} 850. For example, t2 may represent a time value expressed in a suitable unit of time, such as milliseconds or microseconds.

The UL timing 810 shows the application of a first timing advance (e.g., TA_1) 814 at the UE 702 for a first UL transmission (e.g., the first UL signal 714) to the TRP_1 704. The value of the first timing advance (e.g., TA_1) 814 may be approximately equal to twice the propagation delay between the UE 702 and the TRP_1 704. For example, the value of the first timing advance (e.g., TA_1) 814 may be approximately equal to 2 (t1). Therefore, the UE 702 may transmit the first UL transmission a time t1 812 earlier (e.g., relative to the time t_{REF} 850) to compensate for the propagation delay between the UE 702 and the TRP_1 704. In some examples, the expression 2 (t1) may represent a time within a range 0 to 0.67 ms.

The UL timing 816 shows the application of the second timing advance (TA_2) 820 at the UE 702 for a second UL transmission (e.g., the second UL signal 718) to the TRP_2 706. The value of the second timing advance (e.g., TA_2) 816 may be approximately equal to twice the propagation delay between the UE 702 and the TRP_2 706. For example, the value of the second timing advance (e.g., TA_2) 816 may be approximately equal to 2 (t2). Therefore, the UE 702 may transmit the first UL transmission a time t2 818 earlier (e.g., relative to the time t_{REF} 850) to compensate for the propagation delay between the UE 702 and the TRP_2 706. In some examples, the expression 2 (t2) may represent a time within a range 0 to 0.67 ms.

Therefore, the UE 702 may transmit the second UL transmission a time t2 818 earlier (e.g., relative to the time t_{REF} 850) to compensate for the propagation delay between the UE 702 and the TRP_2 706. In some examples, the expression 2 (t2) may represent a time within a range 0 to 0.67 ms. In the example of FIG. 8, since a distance between the UE 702 and the TRP_2 706 may be greater than a distance between the UE 702 and the TRP_1 704, t2 may be greater than t1.

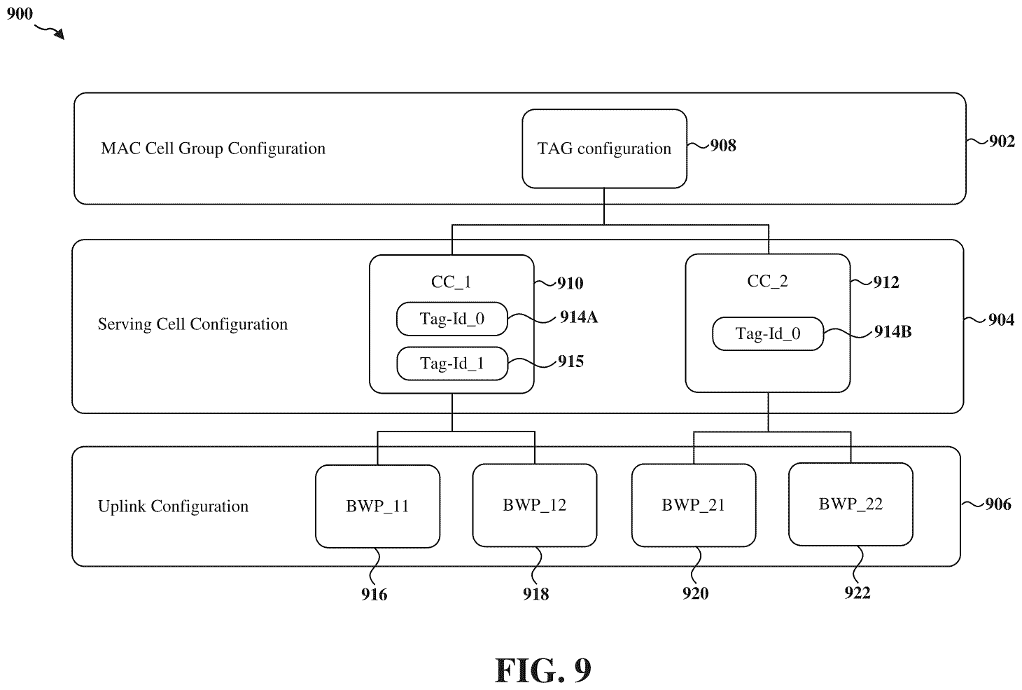

FIG. 9 illustrates an example timing advance configuration diagram 900. The timing advance configuration diagram 900 includes a medium access control (MAC) cell group configuration 902 (also referred to as MAC-CellGroupConfig), a serving cell configuration 904 (also referred to as ServingCellConfig), and an uplink configuration 906. The MAC cell group configuration 902 may include a TAG configuration 908 that applies to multiple component carriers (CCs) indicated in the serving cell configuration 904, such as a first component carrier (CC_1) 910 and a second component carrier (CC_2) 912.

The serving cell configuration 904 may support multiple Tag-Ids per component carrier. For example, the serving cell configuration 904 may configure the first component carrier (CC_1) 910 with two Tag-Ids, such as a first Tag-Id_0 914A and a second Tag-Id_1 915. In the example of FIG. 9, the second component carrier (CC_2) 912 is configured with one Tag-Id, such as the first Tag-Id_0 914B. In some examples, the first Tag-Id_0 914A, 914B may be associated with a first timing advance value and the second Tag-Id_1 915 may be associated with a second timing advance value. In some examples, the first and second timing advance values may be different.

The uplink configuration 906 indicates two BWP configurations of the first component carrier (CC_1) 910, such as a configuration for a first BWP 916 (labeled as BWP_11 in FIG. 9) of the CC_1 910 and a configuration for a second BWP 918 (labeled as BWP_12 in FIG. 9) of the CC_1 910. The uplink configuration 906 further indicates two BWP configurations of the second component carrier (CC_2) 912, such as a configuration for a first BWP 920 (labeled as BWP_21 in FIG. 9) of the CC_2 912 and a configuration for a second BWP 922 (labeled as BWP_22 in FIG. 9) of the CC_2 912.

In some examples, a UE (e.g., UE 702) may communicate with multiple TRPs using the same component carrier (e.g., CC_1 910 or CC_2 912). For example, with reference to FIGS. 7 and 9, the UE 702 may be configured to communicate with TRP_1 704 using the first BWP 916 of CC_1 910 and TRP_2 706 using the second BWP 918 of the CC_1 910. If a distance between the UE 702 and TRP_1 704 is different from a distance between the UE 702 and TRP_2 704, the UE 702 may experience different propagation delays with respect to TRP_1 704 and TRP_2 706. Therefore, the UE 702 may apply different timing advance values to compensate for the different propagation delays.

In one example, Tag-Id_0 914A configured for the CC_1 910 may be associated with TRP_1 704 and the Tag-Id_1 915 configured for CC_1 910 may be associated with TRP_2 706. In some examples, each tag-Id (e.g., Tag-Id_0 914A, Tag-Id_1 915) may indicate a different TAG, where each different TAG is associated with a different timing advance value. It should be noted that each of the bandwidth parts of CC_1 910 (e.g., the first and second BWPs 916, 918 of the CC_1 910) are configured with both the Tag-Id_0 914A and Tag-Id_1 915. Therefore, if a bandwidth part of the CC_1 910 (e.g., the first BWP 916) is to be configured for single TRP operation, an additional configuration may be needed to indicate one of the Tag-Id_0 914A and Tag-Id_1 915 for the first BWP 916.

### First Example Timing Advance Configuration

A first example timing advance configuration will now be described with reference to FIGS. 7 and 10-13. In the first example timing advance configuration, a serving cell may be configured with first timing advance information (e.g., a first Tag-Id) for a component carrier, and a bandwidth part of the component carrier may be configured with second timing advance information (e.g., a second Tag-Id).

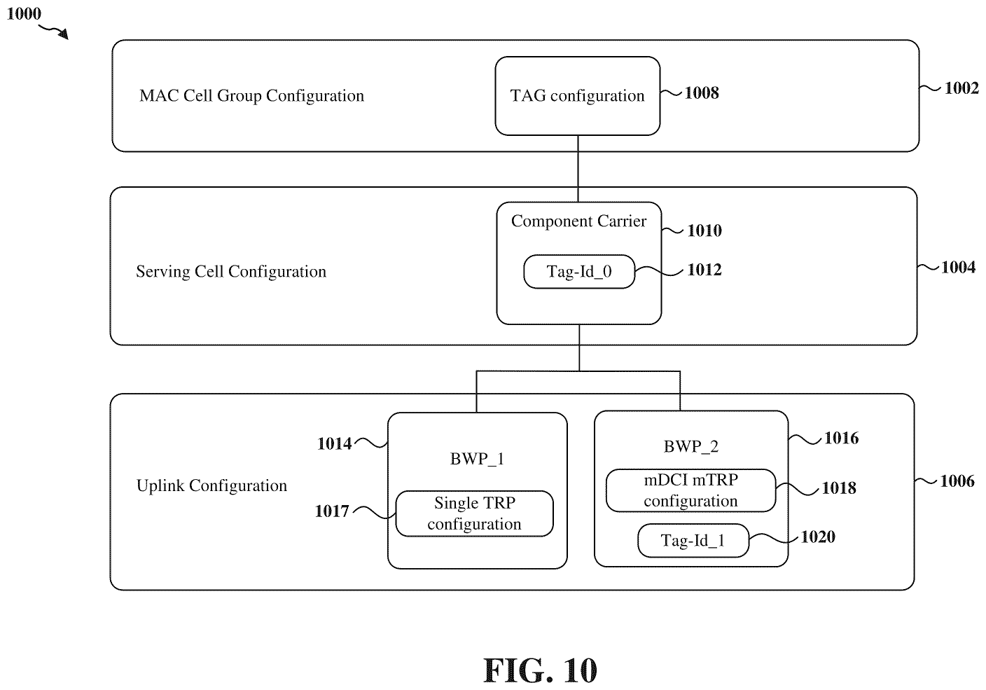

FIG. 10 illustrates a configuration diagram 1000 for the first example timing advance configuration in accordance with various aspects of the disclosure. The configuration diagram 1000 includes a MAC cell group configuration 1002 (also referred to as MAC-CellGroupConfig), a serving cell configuration 1004 (also referred to as ServingCellConfig), and an uplink configuration 1006. The MAC cell group configuration 1002 may include a TAG configuration 1008 that applies to component carriers (CCs) indicated in the serving cell configuration 1004, such as the component carrier 1010.

The serving cell configuration 1004 may support one Tag-Id for the component carrier 1010 of the serving cell. For example, the serving cell configuration 1004 may configure the component carrier 1010 with a first Tag-Id (Tag-Id_0) 1012. In some examples, the first Tag-Id (Tag-Id_0) 1012 may be associated with a first timing advance value.

The uplink configuration 1006 includes configurations for BWPs (also referred to as BWP configurations) of the component carrier 1010, such as a configuration for a first BWP 1014 (labeled as BWP_1 in FIG. 10) and a configuration for a second BWP 1016 (labeled as BWP_2 in FIG. 10). For example, the configuration for the first BWP 1014 may include a single TRP configuration 1017 to support single TRP operation in the uplink and the configuration for the second BWP 1016 may include an mDCI mTRP configuration 1018 to support mDCI mTRP operation in the uplink where different CORESET pool index values may be configured in the corresponding BWP for the DL.

As shown in FIG. 10, the second BWP 1016 may be configured with a second Tag-Id (Tag-Id_1) 1020. In some examples, the second Tag-Id (Tag-Id_1) 1020 may be associated with a second timing advance value. In some examples, the first and second timing advance values may be different.

Therefore, the serving cell (e.g., the component carrier 1010) may be configured with first timing advance information (e.g., Tag-ID_0 1012) and the second BWP 1016 may be configured with second timing advance information (e.g., the second Tag-Id (Tag-Id_1) 1020. It should be noted that the second timing advance information (e.g., the second Tag-Id (Tag-Id_1) 1020) configured for the second BWP 1016 may not be associated with other bandwidth parts (e.g., the first BWP 1014) of the component carrier 1010. In some examples, BWPs that do not include a configuration to support mDCI mTRP operation in the uplink (e.g., BWPs configured for single TRP operation) may not be configured with BWP specific timing advance information (e.g., the second Tag-Id (Tag-Id_1) 1020).

A UE (e.g., UE 702) may communicate with multiple TRPs using a BWP configured to support mDCI mTRP operation. For example, with reference to FIGS. 7 and 10, the UE 702 may use the second BWP 1016 to transmit the first UL signal 714 to TRP_1 704 and to transmit the second UL signal 718 to TRP_2 706. In some examples, at least a portion of the transmission of the first UL signal 714 may be concurrent with at least a portion of the transmission of the second UL signal 718.

The association between two TAGs and two TRPs may be predetermined based on a rule. In one example, Tag-Id_0 1012 configured for the component carrier 1010 may be associated with TRP_1 704 and the Tag-Id_1 1020 configured for the second BWP 1016 may be associated with TRP_2 706. In this example, the UE 702 may apply the Tag-Id_0 1012 when transmitting the first UL signal 714 to TRP_1 704 and may apply the Tag-Id_1 1020 when transmitting the second UL signal 718 to TRP_2 706.

In another example, the UE 702 may communicate with a single TRP (e.g., TRP_1 704) using a BWP configured to support single TRP operation, such as the first BWP 1014. For example, with reference to FIGS. 7 and 10, the UE 702 may use the first BWP 1014 to transmit the first UL signal 714 to TRP_1 704. In one example, the Tag-Id_0 1012 configured for the component carrier 1010 may be associated with TRP_1 704. Therefore, the UE 702 may apply the Tag-Id_0 1012 when transmitting the first UL signal 714 to the TRP_1 704.

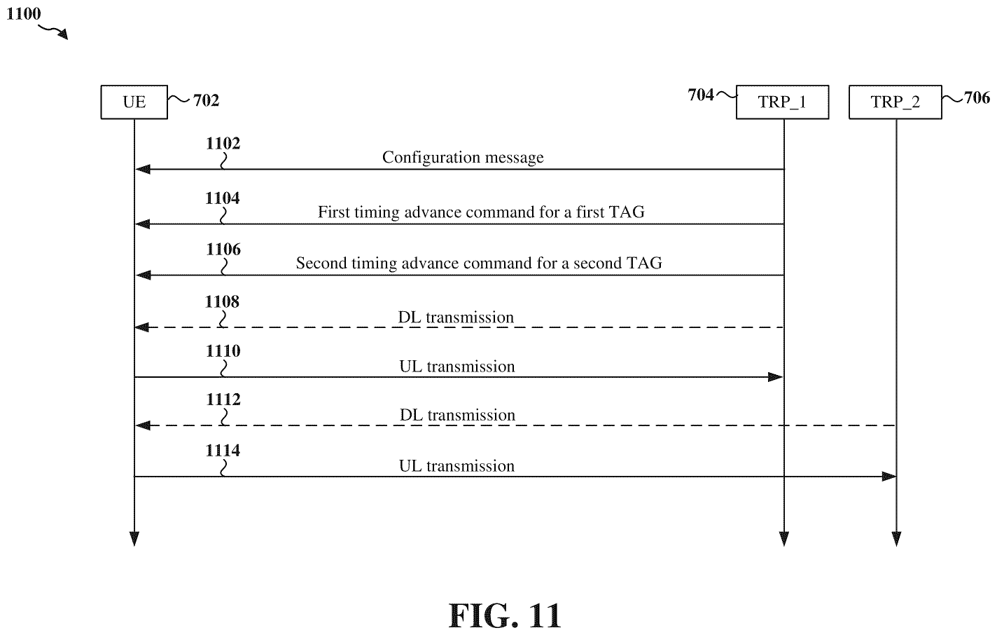

FIG. 11 is a signal flow diagram 1100 in accordance with various aspects of the disclosure. FIG. 11 includes the UE 702, the TRP_1 704, and the TRP_2 706. The UE 702 may receive a configuration message 1102 from the TRP_1 704. In some aspects of the disclosure, the configuration message 1102 may be an RRC configuration message. In some aspects of the disclosure, the configuration message 1102 may include a serving cell configuration and a bandwidth part configuration. In some examples, the serving cell configuration may include first timing advance information for a component carrier and the bandwidth part configuration may include second timing advance information for a bandwidth part of the component carrier.

For example, the serving cell may be associated with a component carrier, such as the component carrier 1010 in FIG. 10. In some examples, the serving cell configuration 1004 (e.g., ServingCellConfig) may include timing advance information for a component carrier as described herein, such as the tag-Id_0 1012 for the component carrier 1010. In some examples, the tag-Id_0 1012 may be associated with a TRP (e.g., the TRP_1 704).

In some examples, the configuration message 1102 may include a configuration for a serving cell (e.g., a ServingCellConfig IE) that includes a parameter (e.g., tag-id_0) for indicating first timing advance information for the serving cell, such as a TAG for the serving cell. The configuration for the serving cell may further include an uplink configuration IE (herein referred to as an uplinkConfig IE) for the serving cell, and an additional uplink configuration IE (herein referred to as a supplementaryUplink IE) for the serving cell. An example structure of a ServingCellConfig IE may be represented using ASN.1 code as follows:

```
ServingCellConfig ::= SEQUENCE {
  ...
  tag-Id_0, TAG-Id
  uplinkConfig, UplinkConfig
  supplementaryUplink, UplinkConfig
  ...
}.
```

The uplinkConfig IE may configure one or more uplink BWPs for the serving cell. For example, the uplinkConfig IE may include a parameter (herein referred to as uplinkBWP-ToReleaseList) for indicating a list of uplink BWPs to be released (e.g., removed) in a serving cell, a parameter (herein referred to as uplinkBWP-ToAddModList) for indicating a list of uplink BWPs to be added in a serving cell, and an uplink channel configuration (herein referred to as pusch-ServingCellConfig) for an uplink data channel (e.g., PUSCH) in the serving cell. In some examples, the uplinkBWP-ToAddModList parameter may indicate that multiple uplink BWPs are configured for a serving cell. An example structure of an uplinkConfig IE may be represented using ASN.1 code as follows:

```
UplinkConfig ::= SEQUENCE {
  ...
  uplinkBWP-ToReleaseList
  uplinkBWP-ToAddModList
  pusch-ServingCellConfig
  ...
}.
```

In some examples, the configuration message 1102 may include an uplink BWP IE (herein referred to as a BWP-Uplink IE) for configuring an uplink BWP of a serving cell (e.g., a component carrier). In some examples, the BWP-Uplink IE may include a parameter (herein referred to as bwp-Id) for indicating an identifier of a BWP, a parameter (herein referred to as bwp-Common) for indicating a cell specific configuration for a BWP, a parameter (herein referred to as bwp-Dedicated) for indicating a UE specific configuration for a BWP, and a parameter (herein referred to as tag-Id_1) for configuring second timing advance information for a bandwidth part, such as a TAG for the BWP. For example, the parameter bwp-Dedicated may include a BWP configuration (e.g., an mDCI mTRP configuration 1018) that enables the BWP to support mDCI mTRP operation in the uplink. An example structure of a BWP-Uplink IE may be represented using ASN.1 code as follows:

```
BWP-Uplink ::= SEQUENCE {
  bwp-Id BWP-Id,
  bwp-Common BWP-UplinkCommon
  bwp-Dedicated BWP-UplinkDedicated
  tag-Id_1, TAG-Id
  ...
}.
```

With reference to FIG. 11, the UE 702 may receive a first timing advance command 1104 for a first timing advance group (TAG) (also referred to as a first timing advance command 1104). For example, the first timing advance command 1104 may include a first timing advance group identifier and a first timing advance value associated with the first timing advance group identifier. In one example, the first timing advance group identifier may be the tag-Id_0 1012 configured for the component carrier 1010.

The UE 702 may further receive a second timing advance command 1106 for a second timing advance group (TAG) (also referred to as a second timing advance command 1106). For example, the second timing advance command 1106 may include a second timing advance group identifier and a second timing advance value associated with the second timing advance group identifier. In one example, the second timing advance group identifier may be the tag-Id_1 1020 configured for a BWP (e.g., the second BWP 1016) of the component carrier 1010.

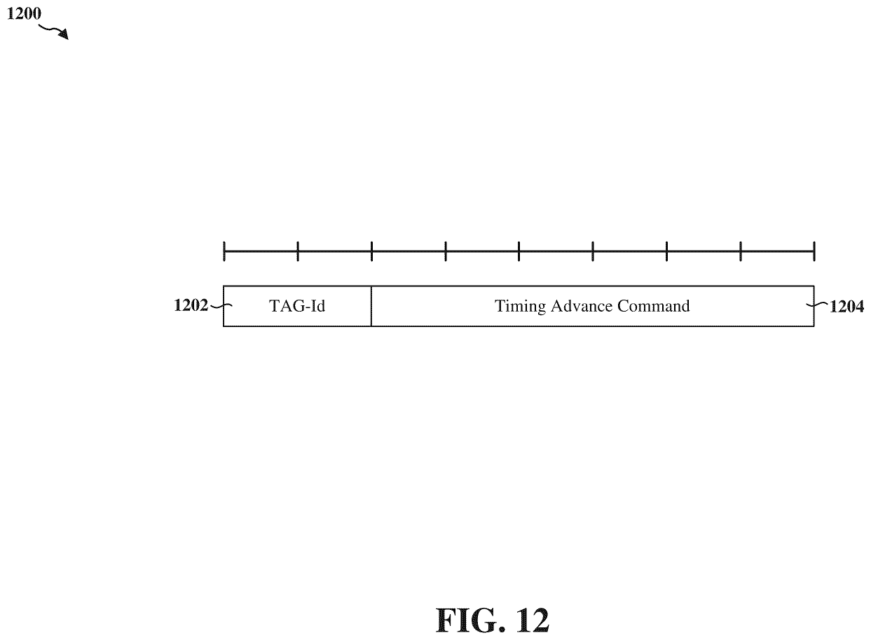

In some examples, each of the first and second timing advance commands 1104, 1106 may be a timing advance command MAC-CE (e.g., the timing advance command MAC-CE 1200 described with reference to FIG. 12). In one example, the first timing advance value in the first timing advance command 1104 may be a first time value expressed in a suitable unit of time, such as milliseconds or microseconds. The second timing advance value in the second timing advance command 1106 may be a second time value expressed in a suitable unit of time, such as milliseconds or microseconds.

The UE 702 may optionally receive a first DL transmission 1108 from the TRP_1 704. The UE 702 may transmit a first UL transmission 1110 to the TRP_1 704. The UE 702 may optionally receive a second DL transmission 1112 from the TRP_2 706. The UE 702 may transmit a second UL transmission 1114 to the TRP_2 706.

The UE 702 may apply the first timing advance value in the first timing advance command 1104 to the first UL transmission 1110 and may apply the second timing advance value in the second timing advance command 1106 to the second UL transmission 1114. In some examples, the UE 702 may transmit the first and second UL transmissions 1110, 1114 using a BWP of a component carrier configured for mDCI mTRP operation, such as the second BWP 1016 shown in FIG. 10.

FIG. 12 illustrates an example timing advance command medium access control (MAC) control element (MAC-CE) 1200 for indicating a timing advance command to a UE. As shown in FIG. 12, the MAC-CE 1200 may include a timing advance group identifier (TAG-Id) field 1202 and a timing advance command field 1204. The TAG-Id field 1202 may include two bits and may be used to indicate a timing advance group (TAG). The timing advance command field 1204 may include a 6-bit timing advance command that is to be applied to cells in the indicated TAG. For example, the 6-bit timing advance command may indicate an index value TA=(0, 1, 2, . . . , 63) that is used to control the amount of timing adjustment that a UE (e.g., UE 702) applies to an uplink transmission.

In some aspects described herein, the term “timing advance value” may refer to the amount of timing adjustment (e.g., in terms of a time value expressed in a suitable unit of time, such as milliseconds or microseconds) a UE (e.g., UE 702) may apply to uplink transmissions. In some examples, the amount of the timing adjustment may be indicated with the previously described index value TA in a timing advance command.

In one example, a UE (e.g., UE 702) may store the latest timing advance adjustment value and when a new timing advance command is received, the UE may obtain the index value TA and may determine a new timing adjustment value based on equation 1:

$${N}_{TA \_} new = {N}_{T A \_} old + ( {T}_{A} - 31 ) \cdot 16 \cdot 64 / {2}^{μ} \qquad ( equation l )$$

where N_{TA}_new represents the new timing adjustment value, N_{TA}_old represents the latest timing adjustment value, TA represents an index value between 0 to 63, and u represents the subcarrier spacing numerology parameter.

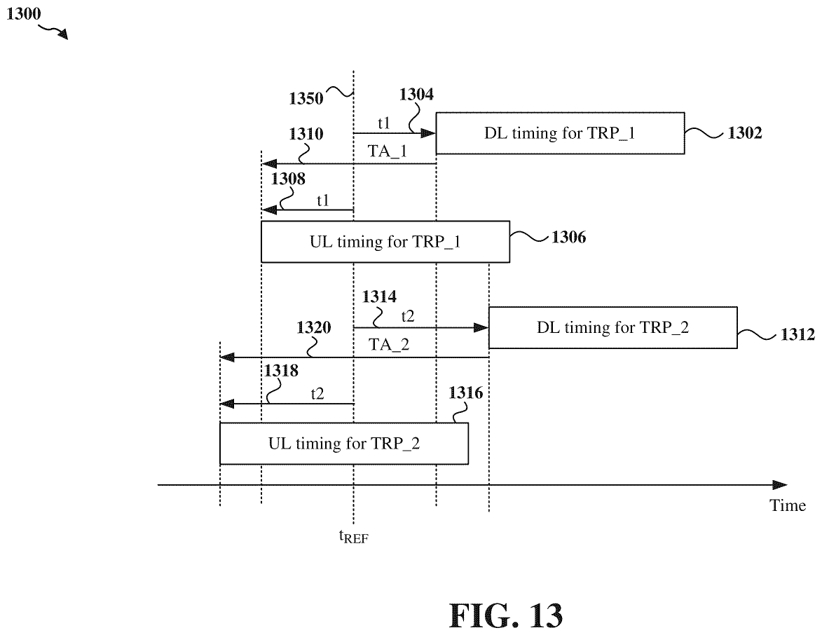

FIG. 13 shows an example timing diagram 1300 for the signal flow diagram 1100 in FIG. 11. The timing diagram 1300 includes a DL timing 1302 for the TRP_1 704, a UL timing 1306 for the TRP_1 704, a DL timing 1312 for the TRP_2 706, and a UL timing 1316 for the TRP_2 706. The DL timing 1302 shows the propagation delay t1 1304 for a DL transmission (e.g., the first DL transmission 1108) transmitted at a time t_{REF} 1350. For example, t1 may represent a time value expressed in a suitable unit of time, such as milliseconds or microseconds. The DL timing 1312 shows the propagation delay t2 1314 for a DL transmission (e.g., the second DL transmission 1112) transmitted at the time t_{REF} 1350. For example, t2 may represent a time value expressed in a suitable unit of time, such as milliseconds or microseconds.

The UL timing 1306 shows the application of the first timing advance (e.g., TA_1) 1310 at the UE 702 for the first UL transmission 1110 to the TRP_1 704. The value of the first timing advance (e.g., TA_1) 1310 may be approximately equal to the first timing advance value associated with the first timing advance group identifier (e.g., the tag-Id_0 1012) and may be approximately equal to twice the propagation delay between the UE 702 and the TRP_1 704.

For example, the value of the first timing advance (e.g., TA_1) 1310 may be approximately equal to 2 (t1). Therefore, the UE 702 may transmit the first UL transmission 1110 a time t1 1308 earlier (e.g., relative to the time t_{REF} 1350) to compensate for the propagation delay between the UE 702 and the TRP_1 704. In some examples, the expression 2 (t1) may represent a time within a range 0 to 0.67 ms.

The UL timing 1316 shows the application of the second timing advance (TA_2) 1320 at the UE 702 for the second UL transmission 1114 to the TRP_2 706. The value of the second timing advance (e.g., TA_2) 1320 may be approximately equal to the second timing advance value associated with the first timing advance group identifier (e.g., the tag-Id_1 1020) and may be approximately equal to twice the propagation delay between the UE 702 and the TRP_2 706.

For example, the value of the second timing advance (e.g., TA_2) 1320 may be approximately equal to 2 (t2). Therefore, the UE 702 may transmit the second UL transmission 1114 a time t2 1318 earlier (e.g., relative to the time t_{REF} 1350) to compensate for the propagation delay between the UE 702 and the TRP_2 706. In some examples, the expression 2 (12) may represent a time within a range 0 to 0.67 ms. In the example of FIG. 13, since a distance between the UE 702 and the TRP_2 706 may be greater than a distance between the UE 702 and the TRP_1 704, t2 may be greater than t1.

### Second Example Timing Advance Configuration

A second example timing advance configuration will now be described with reference to FIGS. 7 and 14-17. In the second example timing advance configuration, a serving cell may be configured with first timing advance information (e.g., a Tag-Id) for a component carrier, and a bandwidth part of the component carrier may be configured with second timing advance information. The second timing advance information may include a timing advance offset identifier (e.g., a TAoffsetId) for a BWP of the component carrier. A UE (e.g., UE 702) may apply a first timing advance value associated with the first timing advance information to a first uplink transmission to a first TRP (e.g., the TRP_1 704), and may apply a sum of the first timing advance value and a second timing advance value (e.g., a timing advance offset value) associated with the second timing advance information to a second uplink transmission to a second TRP (e.g., the TRP_2 706).

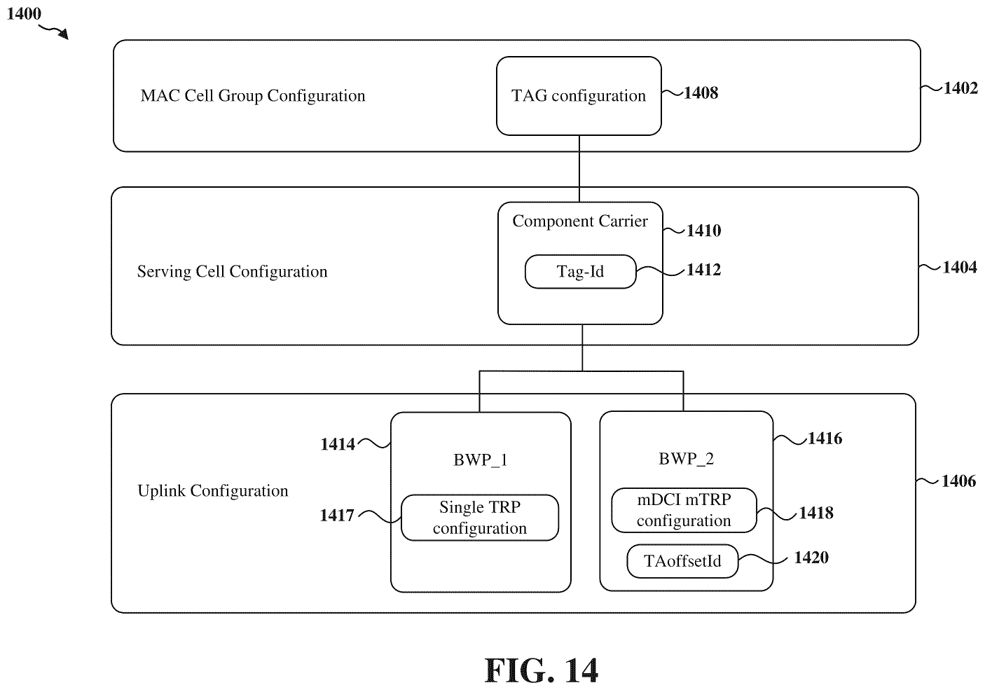

FIG. 14 illustrates a configuration diagram 1400 for the second example timing advance configuration in accordance with various aspects of the disclosure. The configuration diagram 1400 includes a MAC cell group configuration 1402 (also referred to as MAC-CellGroupConfig), a serving cell configuration 1404 (also referred to as ServingCellConfig), and an uplink configuration 1406. The MAC cell group configuration 1402 may include a TAG configuration 1408 that applies to component carriers (CCs) indicated in the serving cell configuration 1404, such as the component carrier 1410.

The serving cell configuration 1404 may support one Tag-Id for the component carrier 1410 of the serving cell. For example, the serving cell configuration 1404 may configure the component carrier 1410 with a Tag-Id 1412. In some examples, the Tag-Id 1412 may be associated with a first timing advance value.

The uplink configuration 1406 includes configurations for BWPs (also referred to as BWP configurations) of the component carrier 1410, such as a configuration for a first BWP 1414 (labeled as BWP_1 in FIG. 14) and a configuration for a second BWP 1416 (labeled as BWP_2 in FIG. 14). For example, the configuration for the first BWP 1414 may include a single TRP configuration 1417 to support single TRP operation in the uplink and the configuration for the second BWP 1416 may include an mDCI mTRP configuration 1418 to support mDCI mTRP operation in the uplink where different CORESET pool index values may be configured in the corresponding BWP for the DL.

As shown in FIG. 14, the second BWP 1416 may be configured with a timing advance offset identifier (TAoffsetId) 1420. In some examples, the timing advance offset identifier (TAoffsetId) 1420 may be associated with a second timing advance value. In some examples, the second timing advance value may include a timing advance offset value.

It should be noted that the second timing advance information (e.g., the timing advance offset identifier (TAoffsetId) 1420) configured for the second BWP 1416 may not be associated with other bandwidth parts (e.g., the first BWP 1414) of the component carrier 1410. In some examples, BWPs that do not include a configuration to support mDCI mTRP operation in the uplink (e.g., BWPs configured for single TRP operation) may not be configured with BWP specific timing advance information (e.g., the timing advance offset identifier (TAoffsetId) 1420).

A UE (e.g., UE 702) may communicate with multiple TRPs using a BWP configured to support mDCI mTRP operation. For example, with reference to FIGS. 7 and 14, the UE 702 may use the second BWP 1416 to transmit the first UL signal 714 to the TRP_1 704 and to transmit the second UL signal 718 to the TRP_2 706. In some examples, at least a portion of the transmission of the first UL signal 714 may be concurrent with at least a portion of the transmission of the second UL signal 718.

In one example, the Tag-Id 1412 configured for the component carrier 1410 may be associated with the TRP_1 704 and the TRP_2 706. The timing advance offset identifier (TAoffsetId) 1420 configured for the second BWP 1416 may be associated with the TRP_2 706. In this example, the UE 702 may apply the Tag-Id 1412 (e.g., a first timing advance value associated with the Tag-Id 1412) when transmitting the first UL signal 714 to the TRP_1 704 and may apply the Tag-Id 1412 and the timing advance offset identifier (TAoffsetId) 1420 (e.g., a first timing advance value associated with the Tag-Id 1412 and a second timing advance value associated with the timing advance offset identifier (TAoffsetId) 1420) when transmitting the second UL signal 718 to the TRP_2 706.

In another example, the UE 702 may communicate with a single TRP (e.g., the TRP_1 704) using a BWP configured to support single TRP operation, such as the first BWP 1414. For example, with reference to FIGS. 7 and 14, the UE 702 may use the first BWP 1414 to transmit the first UL signal 714 to the TRP_1 704. In one example, the Tag-Id 1412 configured for the component carrier 1410 may be associated with the TRP_1 704. Therefore, the UE 702 may apply the Tag-Id 1412 when transmitting the first UL signal 714 to the TRP_1 704.

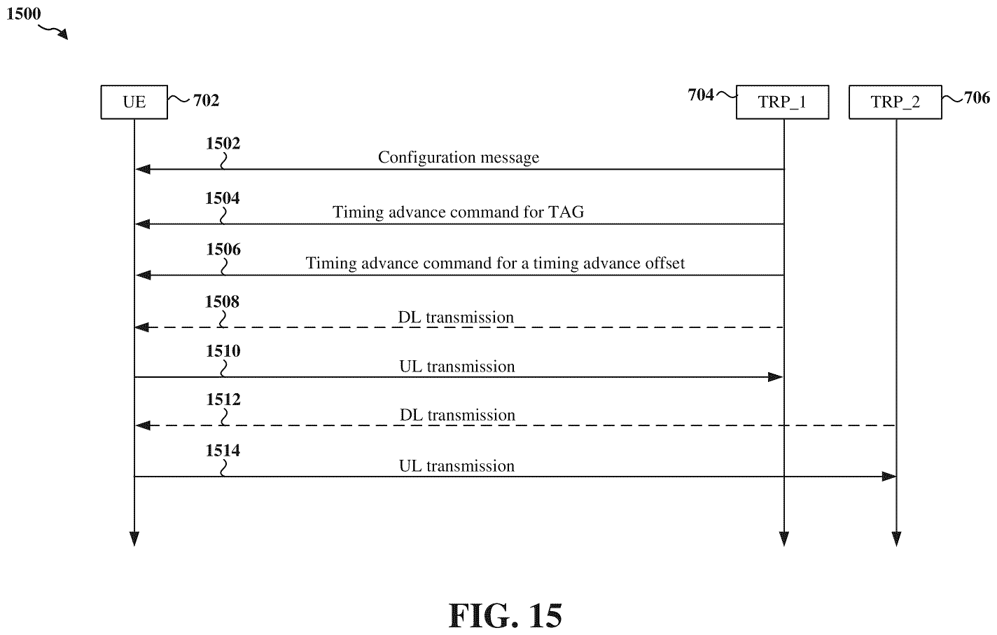

FIG. 15 is a signal flow diagram 1500 in accordance with various aspects of the disclosure. FIG. 15 includes the UE 702, the TRP_1 704, and the TRP_2 706. The UE 702 may receive a configuration message 1502 from the TRP_1 704. In some aspects of the disclosure, the configuration message 1502 may be an RRC configuration message. In some aspects of the disclosure, the configuration message 1502 may include a serving cell configuration and a bandwidth part configuration. In some examples, the serving cell configuration may include first timing advance information for a component carrier and the bandwidth part configuration may include second timing advance information for a bandwidth part of the component carrier.

For example, the serving cell may be associated with a component carrier, such as the component carrier 1410 in FIG. 14. In some examples, the serving cell configuration 1404 (e.g., ServingCellConfig) may include timing advance information for a component carrier as described herein, such as the tag-Id 1412 for the component carrier 1410. In some examples, the tag-Id 1412 may be associated with a TRP (e.g., the TRP_1 704).

In some examples, the configuration message 1502 may include a configuration for a serving cell (e.g., a ServingCellConfig IE) that includes a parameter (e.g., tag-Id) for indicating first timing advance information for the serving cell, such as a TAG for the serving cell. The configuration for the serving cell may further include an uplink configuration IE (herein referred to as an uplinkConfig IE) for the serving cell, and an additional uplink configuration IE (herein referred to as a supplementaryUplink IE) for the serving cell. An example structure of a ServingCellConfig IE may be represented using the Abstract Syntax Notation One (ASN.1) code as follows:

```
ServingCellConfig ::= SEQUENCE {
  ...
  tag-Id, TAG-Id
  uplinkConfig, UplinkConfig
  supplementary Uplink, UplinkConfig
  ...
}.
```

The uplinkConfig IE may configure one or more uplink BWPs for the serving cell. For example, the uplinkConfig IE may include a parameter (herein referred to as uplinkBWP-ToReleaseList) for indicating a list of uplink BWPs to be released (e.g., removed) in a serving cell, a parameter (herein referred to as uplinkBWP-ToAddModList) for indicating a list of uplink BWPs to be added in a serving cell, and an uplink channel configuration (herein referred to as pusch-ServingCellConfig) for an uplink data channel (e.g., PUSCH) in the serving cell. In some examples, the uplinkBWP-ToAddModList parameter may indicate that multiple uplink BWPs are configured for a serving cell. An example structure of an uplinkConfig IE may be represented using the ASN.1 code as follows:

```
UplinkConfig ::= SEQUENCE {
  ...
  uplinkBWP-ToReleaseList
  uplinkBWP-ToAddModList
  pusch-ServingCellConfig
  ...
}.
```

In some examples, the configuration message 1502 may include an uplink BWP IE (herein referred to as a BWP-Uplink IE) for configuring an uplink BWP of a serving cell (e.g., a component carrier). In some examples, the BWP-Uplink IE may include a parameter (herein referred to as bwp-Id) for indicating an identifier of a BWP, a parameter (herein referred to as bwp-Common) for indicating a cell specific configuration for a BWP, a parameter (herein referred to as bwp-Dedicated) for indicating a UE specific configuration for a BWP, and a parameter (herein referred to as TAoffsetId) for configuring second timing advance information for a BWP, such as a timing advance offset TAG for the BWP. For example, the parameter bwp-Dedicated may include a BWP configuration (e.g., an mDCI mTRP configuration 1418) that enables the BWP to support mDCI mTRP operation in the uplink. An example structure of a BWP-Uplink IE may be represented using the ASN.1 code as follows:

```
BWP-Uplink ::= SEQUENCE {
  bwp-Id BWP-Id,
  bwp-Common BWP-UplinkCommon
  bwp-Dedicated BWP-UplinkDedicated
  TAoffsetId, TAoffsetTAG-Id
  ...
}.
```

With reference to FIG. 15, the UE 702 may receive a timing advance command 1504 for a first timing advance group (TAG) (also referred to as a timing advance command 1504). For example, the timing advance command 1504 may include a timing advance group identifier and a first timing advance value associated with the timing advance group identifier. In one example, the timing advance group identifier may be the tag-Id 1412 configured for the component carrier 1410.

The UE 702 may further receive a timing advance command 1506 for a timing advance offset. For example, the timing advance command 1506 for a timing advance offset may include a timing advance offset identifier and a second timing advance value associated with the timing advance offset identifier. In one example, the second timing advance value may be a timing advance offset value represented as 2 (δt), where δt may be a time value expressed in a suitable unit of time, such as milliseconds or microseconds. In one example, the timing advance offset identifier may be the TAoffsetId 1420 configured for a BWP (e.g., the second BWP 1416) of the component carrier 1410.

In some examples, the timing advance command 1504 may be a timing advance command MAC-CE (e.g., the timing advance command MAC-CE 1200 described with reference to FIG. 12). In one example, the first timing advance value in the timing advance command 1504 may be a time value expressed in a suitable unit of time, such as milliseconds or microseconds.

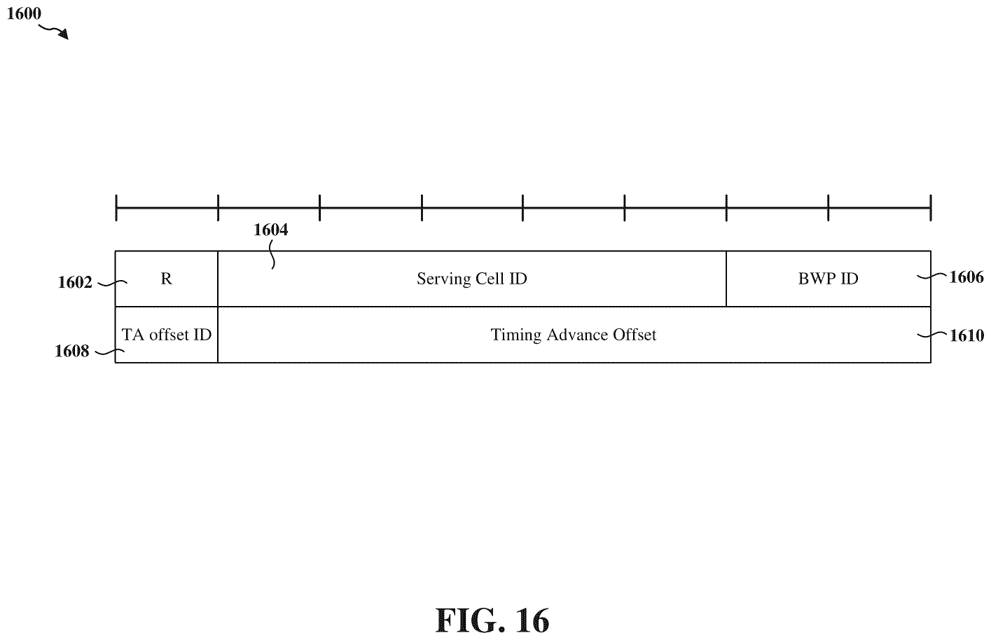

In some examples, the timing advance command 1506 for a timing advance offset may be a timing advance command MAC-CE for indicating a timing advance offset (e.g., the timing advance command MAC-CE 1600 described with reference to FIG. 16). In one example, the timing advance offset may be 2 (δt).

FIG. 16 illustrates an example timing advance command MAC-CE 1600 for indicating a timing advance offset to a UE. As shown in FIG. 16, the timing advance command MAC-CE 1600 may include a reserved bit field (R) 1602, a serving cell identifier field (Serving Cell ID) 1604, a BWP identifier field (BWP ID) 1606, a timing advance offset identifier field (TA offset ID) 1608, and a timing advance offset field 1610.

In some examples, the serving cell identifier field 1604 may include five bits and may be used to indicate a serving cell of the UE. The BWP identifier field (BWP ID) 1606 may include two bits and may indicate a BWP of a serving cell. The timing advance offset identifier field 1608 may include one bit and may indicate a timing advance offset TAG. The timing advance offset field 1610 may include seven bits and may indicate a timing advance offset value (e.g., 2 (δt)).

The UE 702 may optionally receive a first DL transmission 1508 from the TRP_1 704. The UE 702 may transmit a first UL transmission 1510 to the TRP_1 704. The UE 702 may optionally receive a second DL transmission 1512 from the TRP_2 706. The UE 702 may transmit a second UL transmission 1514 to the TRP_2 706.

The UE 702 may apply the first timing advance value in the timing advance command 1504 to the first UL transmission 1510 to the TRP_1 704, and may apply a sum of the first timing advance value in the timing advance command 1504 and the timing advance offset value (e.g., 2 (δt)) in the timing advance command 1506 for a timing advance offset to the second UL transmission 1514 to the TRP_2 706. The sum may be referred to as a second timing advance value. In some examples, the UE 702 may transmit the first and second UL transmissions 1510, 1514 using a BWP of a component carrier configured for mDCI mTRP operation, such as the second BWP 1416 shown in FIG. 14.

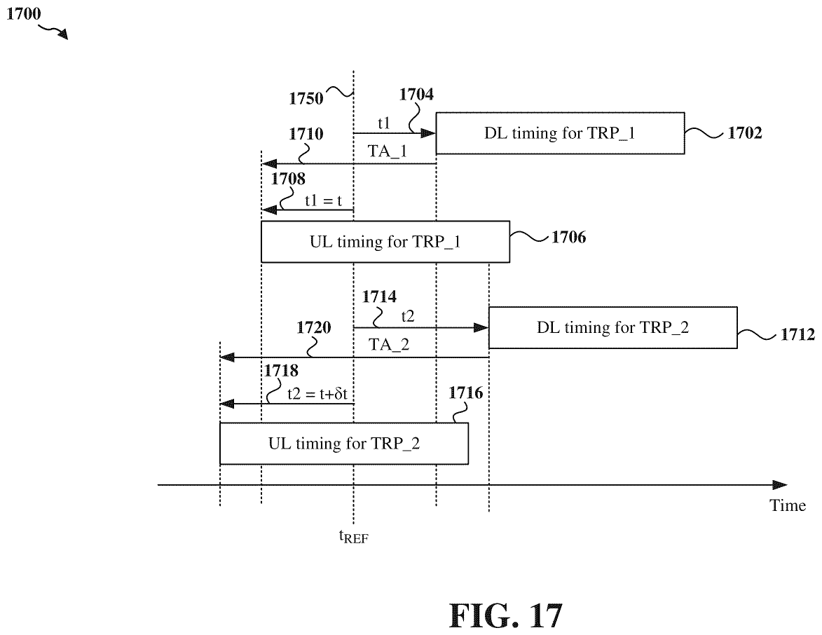

FIG. 17 shows an example timing diagram 1700 for the signal flow diagram 1500 in FIG. 15. The timing diagram 1700 includes a DL timing 1702 for the TRP_1 704, a UL timing 1706 for the TRP_1 704, a DL timing 1712 for the TRP_2 706, and a UL timing 1716 for the TRP_2 706. The DL timing 1702 shows the propagation delay t1 1704 for a DL transmission (e.g., the first DL transmission 1508) transmitted at a time t_{REF} 1750. In some examples, the propagation delay t1 1704 may be approximately equal to a time t. For example, t may represent a time value expressed in a suitable unit of time, such as milliseconds or microseconds. The DL timing 1712 shows the propagation delay t2 1714 for a DL transmission (e.g., the second DL transmission 1512) transmitted at a time t_{REF} 1750. For example, t2 may represent a time value expressed in a suitable unit of time, such as milliseconds or microseconds.

The UL timing 1706 shows the application of a first timing advance (e.g., TA_1) 1710 at the UE 702 for the first UL transmission 1510 to the TRP_1 704. The value of the first timing advance (e.g., TA_1) 1710 may be the first timing advance value associated with the Tag-Id 1412. In some examples, the first timing advance value associated with the Tag-Id 1412 may be approximately equal to twice the propagation delay between the UE 702 and the TRP_1 704.

In some examples, the value of the first timing advance (e.g., TA_1) 1710 may be approximately equal to 2 (t1), or approximately equal to 2t when t1=t. Therefore, the UE 702 may transmit the first UL transmission a time t1 1708 earlier (e.g., relative to the time t_{REF} 1750) to compensate for the propagation delay between the UE 702 and the TRP_1 704. In some examples, the expression 2 (t1) may represent a time within a range 0 to 0.67 ms.

The UL timing 1716 shows the application of a second timing advance (TA_2) 1720 at the UE 702 for the second UL transmission 1514 to the TRP_2 706. The value of the second timing advance (e.g., TA_2) 1720 may be based on the first timing advance value associated with the Tag-Id 1412 (e.g., 2t) and the timing advance offset value (e.g., 2 (δt)) associated with the timing advance offset identifier (TAoffsetId) 1420.

In one example, the UE 702 may determine the value of the second timing advance (TA_2) 1720 by determining the sum of the first timing advance value associated with the Tag-Id 1412 (e.g., 2t) and the second timing advance value associated with the timing advance offset identifier (TAoffsetId) 1420 (e.g., 2 (δt)). Therefore, in one example, the value of the second timing advance (TA_2) 1720 may be expressed as 2t+2 (δt). In some examples, the expression 2t+2 (δt) may represent a time within a range 0 to 0.67 ms.

In some examples, the sum of the first timing advance value associated with the Tag-Id 1412 (e.g., 2t) and the second timing advance value associated with the timing advance offset identifier (TAoffsetId) 1420 (e.g., 2 (δt)) may be approximately equal to twice the propagation delay between the UE 702 and the TRP_2 706. Therefore, the UE 702 may transmit the second UL transmission 1514 a time t2 1718 earlier (e.g., relative to the time t_{REF} 1750) to compensate for the propagation delay between the UE 702 and the TRP_2 706, where the time t2 is approximately equal to t+δt.

It should be noted that in the second example timing advance configuration, the first timing advance (TA_1) may be based on an absolute time value (e.g., 2t) and the second timing advance (TA_2) may be based on the absolute time value (e.g., 2t) plus an additional offset time (e.g., 2 (δt)). In some examples, the absolute time value (e.g., 2t) may be an accumulative value and the additional offset time (e.g., 2 (δt)) may be a one-shot value.

### Third Example Timing Advance Configuration

A third example timing advance configuration will now be described with reference to FIGS. 7 and 18-20. In the third example timing advance configuration, a serving cell may be configured with first timing advance information (e.g., a Tag-Id) for a component carrier, and a bandwidth part of the component carrier may be configured with second timing advance information and third timing advance information. The second timing advance information may include a first timing advance offset identifier (e.g., a TAoffsetId_0) for a BWP of the component carrier, and the third timing advance information may include a second timing advance offset identifier (e.g., a TAoffsetId_1) for the BWP of the component carrier.

A UE (e.g., UE 702) may apply a sum of a first timing advance value associated with the first timing advance information (e.g., a Tag-Id) for the component carrier and a second timing advance value (e.g., a first timing advance offset value) associated with the second timing advance information to a first uplink transmission to a first TRP (e.g., TRP_1 704). The UE (e.g., UE 702) may apply a sum of the first timing advance value associated with the first timing advance information (e.g., a Tag-Id) for the component carrier and a third timing advance value (e.g., a second timing advance offset value) associated with the third timing advance information to a second uplink transmission to a second TRP (e.g., TRP_2 706).

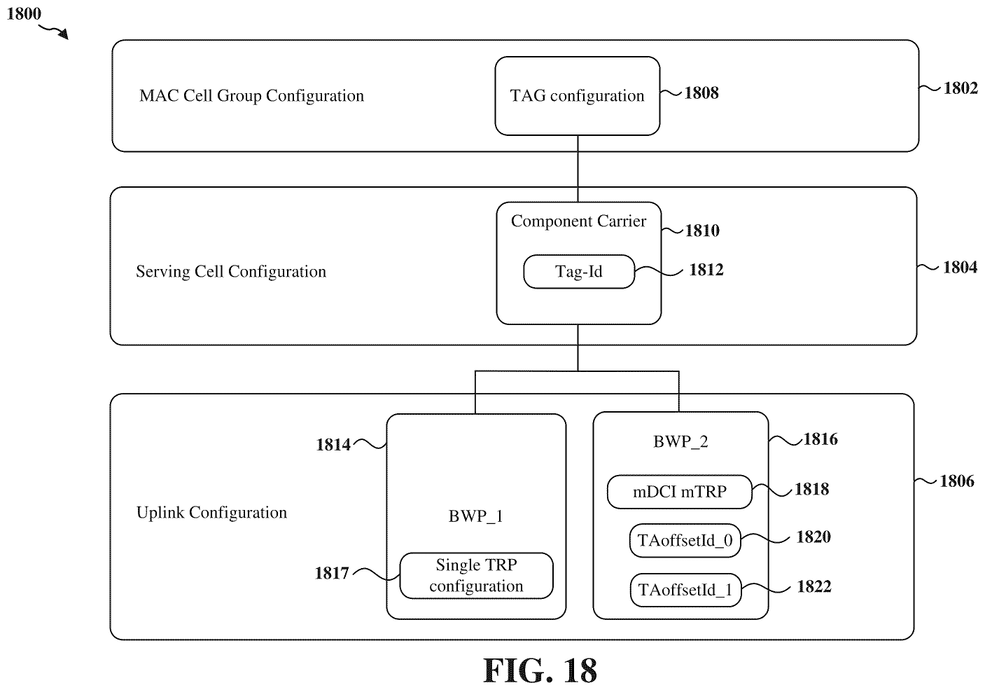

FIG. 18 illustrates a configuration diagram 1800 for the third example timing advance configuration in accordance with various aspects of the disclosure. The configuration diagram 1800 includes a MAC cell group configuration 1802 (also referred to as MAC-CellGroupConfig), a serving cell configuration 1804 (also referred to as ServingCellConfig), and an uplink configuration 1806. The MAC cell group configuration 1802 may include a TAG configuration 1808 that applies to component carriers (CCs) indicated in the serving cell configuration 1804, such as the component carrier 1810.

The serving cell configuration 1804 may support one Tag-Id for the component carrier 1810 of the serving cell. For example, the serving cell configuration 1804 may configure the component carrier 1810 with a Tag-Id 1812. In some examples, the Tag-Id 1812 may be associated with a first timing advance value.

The uplink configuration 1806 includes configurations for BWPs (also referred to as BWP configurations) of the component carrier 1810, such as a configuration for a first BWP 1814 (labeled as BWP_1 in FIG. 18) and a configuration for a second BWP 1816 (labeled as BWP_2 in FIG. 18). For example, the configuration for the first BWP 1814 may include a single TRP configuration 1817 to support single TRP operation in the uplink.

The configuration for the second BWP 1816 may include an mDCI mTRP configuration 1818 to support mDCI mTRP operation in the uplink where different CORESET pool index values may be configured in the corresponding BWP for the DL. The configuration for the second BWP 1816 may further include a first timing advance offset identifier (TAoffsetId_0) 1820 and a second timing advance offset identifier (TAoffsetId_1) 1822. In some examples, the first timing advance offset identifier (TAoffsetId_0) 1820 may be associated with a second timing advance value, and the second timing advance offset identifier (TAoffsetId_1) 1822 may be associated with a third timing advance value. In some examples, the second timing advance value may include a first timing advance offset value, and the third timing advance value may include a second timing advance offset value.

It should be noted that the second timing advance information (e.g., the first timing advance offset identifier (TAoffsetId_0) 1820) and the third timing advance information (e.g., the second timing advance offset identifier (TAoffsetId_1) 1822) configured for the second BWP 1816 may not be associated with other bandwidth parts (e.g., the first BWP 1814) of the component carrier 1810. In some examples, BWPs that do not include a configuration to support mDCI mTRP operation in the uplink (e.g., BWPs configured for single TRP operation) may not be configured with BWP specific timing advance information (e.g., the first timing advance offset identifier (TAoffsetId_0) 1820 and/or the second timing advance offset identifier (TAoffsetId_1) 1822).

A UE (e.g., UE 702) may communicate with multiple TRPs using a BWP configured to support mDCI mTRP operation. For example, with reference to FIGS. 7 and 18, the UE 702 may use the second BWP 1816 to transmit the first UL signal 714 to the TRP_1 704 and to transmit the second UL signal 718 to the TRP_2 706. In some examples, at least a portion of the transmission of the first UL signal 714 may be concurrent with at least a portion of the transmission of the second UL signal 718.

In one example, the Tag-Id 1812 configured for the component carrier 1810 may be associated with the TRP_1 704 and the TRP_2 706. The first timing advance offset identifier (TAoffsetId_0) 1820 configured for the second BWP 1816 may be associated with the TRP_1 706. The second timing advance offset identifier (TAoffsetId_1) 1822 configured for the second BWP 1816 may be associated with the TRP_2 706. In this example, the UE 702 may apply a first timing advance value associated with the Tag-Id 1812 and a second timing advance value associated with the TAoffsetId_0 1820 when transmitting the first UL signal 714 to the TRP_1 704. The UE 702 may apply the first timing advance value associated with the Tag-Id 1812 and a third timing advance value associated with the TAoffsetId_1 1822 when transmitting the second UL signal 718 to the TRP_2 706.

In another example, the UE 702 may communicate with a single TRP (e.g., the TRP_1 704) using a BWP configured to support single TRP operation, such as the first BWP 1814. For example, with reference to FIGS. 7 and 18, the UE 702 may use the first BWP 1814 to transmit the first UL signal 714 to the TRP_1 704. In one example, the Tag-Id 1812 configured for the component carrier 1810 may be associated with the TRP_1 704. Therefore, the UE 702 may apply the first timing advance value associated with the Tag-Id 1812 when transmitting the first UL signal 714 to the TRP_1 704.

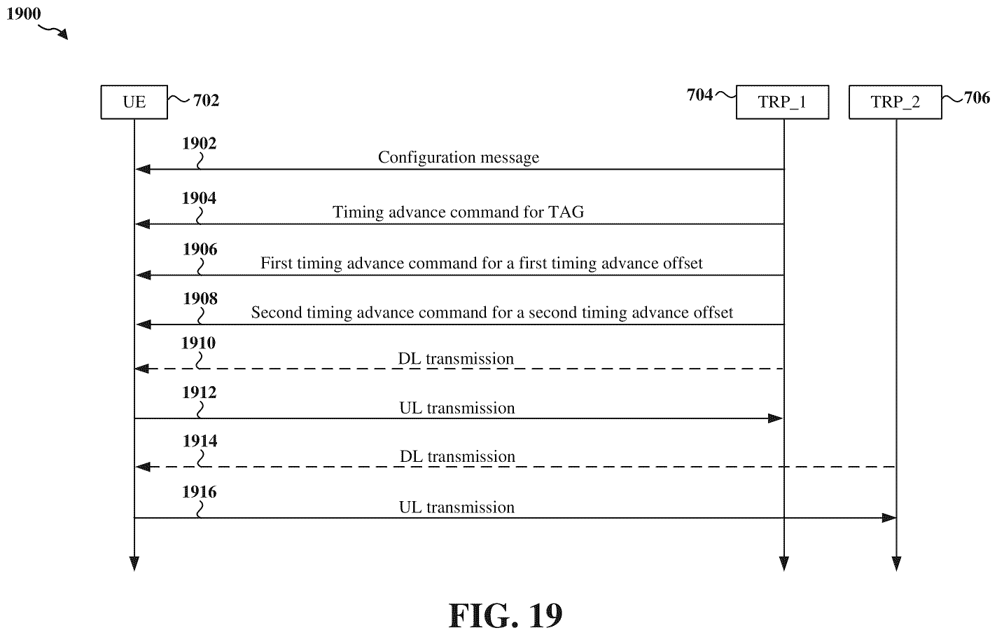

FIG. 19 is a signal flow diagram 1900 in accordance with various aspects of the disclosure. FIG. 19 includes the UE 702, the TRP_1 704, and the TRP_2 706. The UE 702 may receive a configuration message 1902 from the TRP_1 704. In some aspects of the disclosure, the configuration message 1902 may be an RRC configuration message. In some aspects of the disclosure, the configuration message 1902 may include a serving cell configuration and a bandwidth part configuration. In some examples, the serving cell configuration may include first timing advance information for a component carrier. The bandwidth part configuration may include second timing advance information and third timing advance information for a bandwidth part of the component carrier.

For example, the serving cell may be associated with a component carrier, such as the component carrier 1810 in FIG. 18. In some examples, the serving cell configuration 1804 (e.g., ServingCellConfig) may include timing advance information for a component carrier as described herein, such as the tag-Id 1812 for the component carrier 1810. In some examples, the tag-Id 1812 may be associated with multiple TRPs (e.g., the TRP_1 704 and the TRP_2 706).

In some examples, the configuration message 1902 may include a configuration for a serving cell (e.g., a ServingCellConfig IE) that includes a parameter (e.g., tag-Id) for indicating first timing advance information for the serving cell, such as a TAG for the serving cell. The configuration for the serving cell may further include an uplink configuration IE (herein referred to as an uplinkConfig IE) for the serving cell, and an additional uplink configuration IE (herein referred to as a supplementaryUplink IE) for the serving cell. An example structure of a ServingCellConfig IE may be represented using the ASN.1 code as follows:

```
ServingCellConfig ::= SEQUENCE {
  ...
  tag-Id, TAG-Id
  uplinkConfig, UplinkConfig
  supplementaryUplink, UplinkConfig
  ...
}.
```

The uplinkConfig IE may configure one or more uplink BWPs for the serving cell. For example, the uplinkConfig IE may include a parameter (herein referred to as uplinkBWP-ToReleaseList) for indicating a list of uplink BWPs to be released (e.g., removed) in a serving cell, a parameter (herein referred to as uplinkBWP-ToAddModList) for indicating a list of uplink BWPs to be added in a serving cell, and an uplink channel configuration (herein referred to as pusch-ServingCellConfig) for an uplink data channel (e.g., PUSCH) in the serving cell. In some examples, the uplinkBWP-ToAddModList parameter may indicate that multiple uplink BWPs are configured for a serving cell. An example structure of an uplinkConfig IE may be represented using the ASN.1 code as follows:

```
UplinkConfig ::= SEQUENCE {
  ...
  uplinkBWP-ToReleaseList
  uplinkBWP-ToAddModList
  pusch-ServingCellConfig
  ...
}.
```

In some examples, the configuration message 1902 may include an uplink BWP IE (herein referred to as a BWP-Uplink IE) for configuring an uplink BWP of a serving cell (e.g., a component carrier). In some examples, the BWP-Uplink IE may include a parameter (herein referred to as bwp-Id) for indicating an identifier of a BWP, a parameter (herein referred to as bwp-Common) for indicating a cell specific configuration for a BWP, a parameter (herein referred to as bwp-Dedicated) for indicating a UE specific configuration for a BWP, a parameter (herein referred to as TAoffsetId_0) for configuring second timing advance information for a bandwidth part, such as a first timing advance offset TAG for the BWP, and a parameter (herein referred to as TAoffsetId_1) for configuring third timing advance information for a bandwidth part, such as a second timing advance offset TAG for the BWP. For example, the parameter bwp-Dedicated may include a BWP configuration (e.g., the mDCI mTRP configuration 1818) that enables the BWP to support mDCI mTRP operation in the uplink. An example structure of a BWP-Uplink IE may be represented using the ASN.1 code as follows:

```
BWP-Uplink ::= SEQUENCE {
  bwp-Id BWP-Id,
  bwp-Common BWP-UplinkCommon
  bwp-Dedicated BWP-UplinkDedicated
  TAoffsetId_0, TAoffsetTAG-Id
  TAoffsetId_1, TAoffsetTAG-Id
  ...
}.
```

With reference to FIG. 19, the UE 702 may receive a timing advance command 1904 for a timing advance group (TAG) (also referred to as a timing advance command 1904). For example, the timing advance command 1904 may include a timing advance group identifier and a first timing advance value associated with the timing advance group identifier. In one example, the timing advance group identifier may be the tag-Id 1812 configured for the component carrier 1810.

The UE 702 may further receive a first timing advance command 1906 for a first timing advance offset. For example, the first timing advance command 1906 for a first timing advance offset may include a first timing advance offset identifier (e.g., TAoffsetId_0) and a second timing advance value associated with the first timing advance offset identifier. The second timing advance value associated with the first timing advance offset identifier may be a first timing advance offset value represented as 2 (δt₁), where δt₁ may be a time value expressed in a suitable unit of time, such as milliseconds or microseconds. In one example, the first timing advance offset identifier may be the TAoffsetId_0 1820 configured for a BWP (e.g., the second BWP 1816) of the component carrier 1810.

The UE 702 may further receive a second timing advance command 1908 for a second timing advance offset. For example, the second timing advance command 1908 for a second timing advance offset may include a second timing advance offset identifier (e.g., TAoffsetId_1) and a third timing advance value associated with the second timing advance offset identifier. The third timing advance value associated with the second timing advance offset identifier may be a second timing advance offset value represented as 2 (δt₂), where δt₂ may be a time value expressed in a suitable unit of time, such as milliseconds or microseconds. In one example, the second timing advance offset identifier may be the TAoffsetId_1 1822 configured for a BWP (e.g., the second BWP 1816) of the component carrier 1810.

In some examples, the timing advance command 1904 for a timing advance group (TAG) may be a timing advance command MAC-CE (e.g., the timing advance command MAC-CE 1200 described with reference to FIG. 12). In one example, the first timing advance value in the timing advance command 1904 may be a time value expressed in a suitable unit of time, such as milliseconds or microseconds.

In some examples, the first timing advance command 1906 for a first timing advance offset may be a timing advance command MAC-CE for indicating a timing advance offset (e.g., the timing advance command MAC-CE 1600 described with reference to FIG. 16). In one example, the second timing advance value (e.g., in the first timing advance command 1906 for a first timing advance offset) may be a first offset time value (e.g., 2 (δt₁)).

In some examples, the second timing advance command 1908 for a second timing advance offset may be a timing advance command MAC-CE for indicating a timing advance offset (e.g., the timing advance command MAC-CE 1600 described with reference to FIG. 16). In one example, the third timing advance value (e.g., in the second timing advance command 1908 for a second timing advance offset) may be a second offset time value (e.g., 2 (δt₂)).

The UE 702 may optionally receive a first DL transmission 1910 from the TRP_1 704. The UE 702 may transmit a first UL transmission 1912 to the TRP_1 704. The UE 702 may optionally receive a second DL transmission 1914 from the TRP_2 706. The UE 702 may transmit a second UL transmission 1916 to the TRP_2 706.

The UE 702 may apply a sum of the first timing advance value in the timing advance command 1904 for a TAG and a second timing advance value (e.g., a first timing advance offset value 2 (δt₁)) in the first timing advance command 1906 for a first timing advance offset to the first UL transmission 1912 to the TRP_1 704. In one example, the first timing advance value in the timing advance command 1904 for a TAG may be 2t, where t represents a time value expressed in a suitable unit of time, such as milliseconds (ms) or microseconds (μs). In this example, the sum of the first and second timing advance values may be expressed as 2t+2 (δt₁).

The UE 702 may apply a sum of the first timing advance value (e.g., 2t) in the timing advance command 1904 for a TAG and a third timing advance value (e.g., a second timing advance offset value 2 (δt₂)) in the second timing advance command 1908 for a second timing advance offset to the second UL transmission 1916 to the TRP_2 706. In this example, the sum of the first and third timing advance values may be expressed as 2t+2 (δt₂).

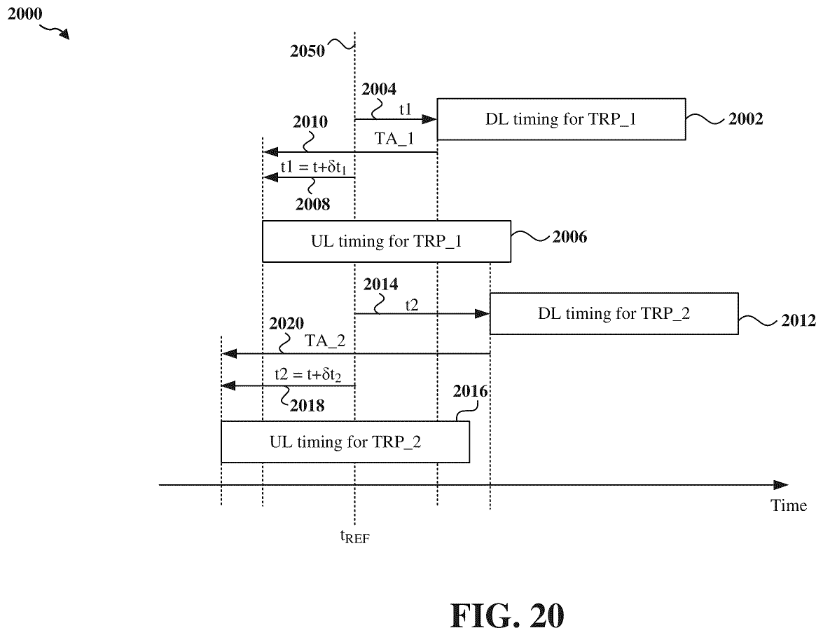

FIG. 20 shows an example timing diagram 2000 for the signal flow diagram 1900 in FIG. 19. The timing diagram 2000 includes a DL timing 2002 for the TRP_1 704, a UL timing 2006 for the TRP_1 704, a DL timing 2012 for the TRP_2 706, and a UL timing 2016 for the TRP_2 706.

The DL timing 2002 shows the propagation delay t1 2004 for a DL transmission (e.g., the first DL transmission 1910) transmitted at a time t_{REF} 2050. The propagation delay t1 2004 may be approximately equal to t+δt₁. For example, t may represent a time value expressed in a suitable unit of time, such as milliseconds or microseconds. The DL timing 2012 shows the propagation delay t2 2014 for a DL transmission (e.g., the second DL transmission 1914) transmitted at a time t_{REF} 2050. The propagation delay t2 2014 may be approximately equal to t+δt₂.

The UL timing 2006 shows the application of a first timing advance (e.g., TA_1) 2010 at the UE 702 for the first UL transmission 1912 to the TRP_1 704. The value of the first timing advance (e.g., TA_1) 2010 may be based on the first timing advance value associated with the Tag-Id 1812 (e.g., 2t) and the first timing advance offset value (e.g., 2 (δt₁) in the first timing advance command 1906 for a first timing advance offset.

In one example, the UE 702 may determine the value of the first timing advance (TA_1) 2010 by determining the sum of the first timing advance value (e.g., 2t) associated with the Tag-Id 1812 and the second timing advance value (e.g., 2 (δt₁) associated with the first timing advance offset identifier (TAoffsetId_0) 1820). Therefore, in one example, the value of the first timing advance (TA_1) 2010 may be expressed as 2t+2 (δt₁). In some examples, the expression 2t+2 (δt₁) may represent a time within a range 0 to 0.67 ms.

In some examples, the sum of the first timing advance value (e.g., 2t) associated with the Tag-Id 1812 and the second timing advance value (e.g., 2 (δt₁) associated with the first timing advance offset identifier (TAoffsetId_0) 1820) may be approximately equal to twice the propagation delay between the UE 702 and the TRP_1 704. Therefore, the UE 702 may transmit the first UL transmission 1912 a time t1 2008 earlier (e.g., relative to the time t_{REF} 2050) to compensate for the propagation delay between the UE 702 and the TRP_1 704, where the time t1 is approximately equal to t+δt₁.

The UL timing 2016 shows the application of a second timing advance (e.g., TA_2) 2020 at the UE 702 for the second UL transmission 1916 to the TRP_2 706. The value of the second timing advance (e.g., TA_2) 2020 may be based on the first timing advance value associated with the Tag-Id 1812 (e.g., 2t) and the second timing advance offset value (e.g., 2 (δt₂) in the second timing advance command 1908 for a second timing advance offset.

In one example, the UE 702 may determine the value of the second timing advance (TA_2) 2020 by determining the sum of the first timing advance value (e.g., 2t) associated with the Tag-Id 1812 and the third timing advance value (e.g., 2 (δt₂) associated with the second timing advance offset identifier (TAoffsetId_1) 1822). Therefore, in one example, the value of the second timing advance (TA_2) 2020 may be expressed as 2t+2 (δt₂). In some examples, the expression 2t+2 (δt₂) may represent a time within a range 0 to 0.67 ms.

In some examples, the sum of the first timing advance value (e.g., 2t) associated with the Tag-Id 1812 and the third timing advance value (e.g., 2 (δt₂) associated with the second timing advance offset identifier (TAoffsetId_1) 1822) may be approximately equal to twice the propagation delay between the UE 702 and the TRP_2 706. Therefore, the UE 702 may transmit the second UL transmission 1916 a time t2 2018 earlier (e.g., relative to the time t_{REF} 2050) to compensate for the propagation delay between the UE 702 and the TRP_2 706, where the time t2 is approximately equal to t+δt₂.

It should be noted that in the third example timing advance configuration, the first and second timing advances (TA_1, TA_2) may be based on an absolute time value (e.g., 2t), with a first additional offset time (e.g., 2 (δt₂)) for the first timing advance (TA_1) and a second additional offset time (e.g., 2 (δt₂)) for the second timing advance (TA_2). In some examples, the absolute time value (e.g., 2t) may be an accumulative value and the additional offset times (e.g., 2 (δt₁), 2 (δt₂)) may be one-shot values.

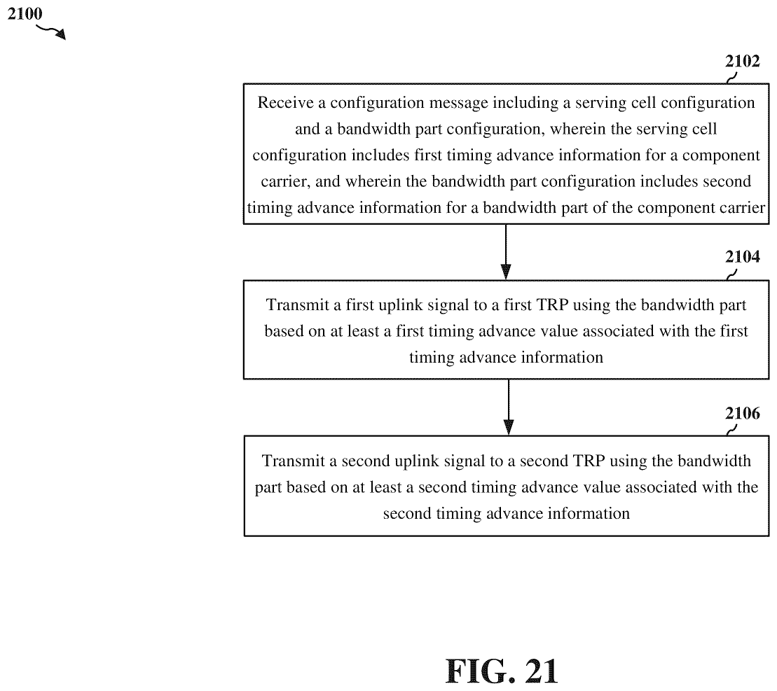

FIG. 21 is a flowchart 2100 of a method of wireless communication. The method may be performed by a UE (e.g., the UE 104, 702; the apparatus 2602/2602′; the processing system 2714, which may include the memory 360 and which may be the entire UE 104, 702 or a component of the UE 104, 702, such as the TX processor 368, the RX processor 356, and/or the controller/processor 359).

At 2102, the UE receives a configuration message including a serving cell configuration and a bandwidth part configuration, wherein the serving cell configuration includes first timing advance information for a component carrier, and wherein the bandwidth part configuration includes second timing advance information for a bandwidth part of the component carrier.

In some examples, the configuration message may be the configuration message 1102 described with reference to FIG. 11 in the first example timing advance configuration. In some examples, the configuration message 1102 may include a configuration for a serving cell (e.g., a ServingCellConfig IE) that includes at least a parameter (e.g., tag-id_0) for indicating first timing advance information for the serving cell, such as a TAG for the serving cell. The configuration message 1102 may further include an uplink BWP IE (e.g., a BWP-Uplink IE) for configuring an uplink BWP of a serving cell (e.g., a component carrier). In some examples, the BWP-Uplink IE may include at least a parameter (herein referred to as tag-Id_1) for configuring second timing advance information for a bandwidth part, such as a TAG for the BWP.

In some examples, the configuration message may be the configuration message 1502 described with reference to FIG. 15 in the second example timing advance configuration. In some examples, the configuration message 1502 may include a configuration for a serving cell (e.g., a ServingCellConfig IE) that includes at least a parameter (e.g., tag-id) for indicating first timing advance information for the serving cell, such as a TAG for the serving cell. The configuration message 1502 may further include an uplink BWP IE (e.g., a BWP-Uplink IE) for configuring an uplink BWP of a serving cell (e.g., a component carrier). In some examples, the BWP-Uplink IE may include at least a parameter (herein referred to as TAoffsetId) for configuring second timing advance information for a BWP, such as a timing advance offset TAG for the BWP.

In some examples, the bandwidth part configuration enables multi-TRP operation for the bandwidth part. For example, the configuration for the second BWP 1016 may include an mDCI mTRP configuration 1018 to support mDCI mTRP operation in the uplink where different CORESET pool index values may be configured in the corresponding BWP for the DL. For example, the configuration for the second BWP 1416 may include an mDCI mTRP configuration 1418 to support mDCI mTRP operation in the uplink where different CORESET pool index values may be configured in the corresponding BWP for the DL.

In some examples, the bandwidth part is one of a plurality of bandwidth parts associated with the component carrier, and the second timing advance information for the bandwidth part is not associated with one or more different bandwidth parts of the plurality of bandwidth parts. In some examples, the one or more different bandwidth parts of the plurality of bandwidth parts are configured for single TRP operation. For example, the configuration for the first BWP 1014 may include a single TRP configuration 1017 to support single TRP operation in the uplink. For example, the configuration for the first BWP 1414 may include a single TRP configuration 1417 to support single TRP operation in the uplink.

At 2104, the UE transmits a first uplink signal to a first TRP using the bandwidth part based on at least a first timing advance value associated with the first timing advance information.

In one example, as described with reference to FIG. 11 in the first example timing advance configuration, the UE 702 may apply a first timing advance value to the first UL transmission 1110 to the TRP_1 704 in a BWP of a component carrier configured for mDCI mTRP operation, such as the second BWP 1016 shown in FIG. 10. For example, the first timing advance information may include the first timing advance group identifier (e.g., the tag-Id_0 1012). In one example, the first timing advance value may be a first time value (e.g., a first time value expressed in a suitable unit of time, such as milliseconds or microseconds) included in the first timing advance command 1104. In one example, with reference to FIG. 13, the UE 702 may apply the first timing advance (e.g., TA_1) 1310 for the first UL transmission 1110 to the TRP_1 704. The value of the first timing advance (e.g., TA_1) 1310 may be approximately equal to the first timing advance value associated with the first timing advance group identifier (e.g., the tag-Id_0 1012) and may be approximately equal to twice the propagation delay between the UE 702 and the TRP_1 704.

In another example, as described with reference to FIG. 15 the second example timing advance configuration, the UE 702 may apply a first timing advance value to the first UL transmission 1510 to the TRP_1 704 in a BWP of a component carrier configured for mDCI mTRP operation, such as the second BWP 1416 shown in FIG. 14. For example, the first timing advance information may include the timing advance group identifier (e.g., the tag-Id 1412) configured for the component carrier 1410. In one example, the first timing advance value may be a first time value (e.g., a first time value expressed in a suitable unit of time, such as milliseconds or microseconds) included in the timing advance command 1504. In one example, with reference to FIG. 17, the UE 702 may apply the first timing advance (e.g., TA_1) 1710 for the first UL transmission 1510 to the TRP_1 704. The value of the first timing advance (e.g., TA_1) 1710 may be approximately equal to the first timing advance value associated with the timing advance group identifier (e.g., tag-Id 1412) and may be approximately equal to twice the propagation delay between the UE 702 and the TRP_1 704. For example, the value of the first timing advance (e.g., TA_1) 1710 may be approximately equal to 2t.

At 2106, the UE transmits a second uplink signal to a second TRP using the bandwidth part based on at least a second timing advance value associated with the second timing advance information.

In one example, as described with reference to FIG. 11, the UE 702 may apply a second timing advance value to the second UL transmission 1114 using a BWP of a component carrier configured for mDCI mTRP operation, such as the second BWP 1016 shown in FIG. 10. For example, the second timing advance information may be the second timing advance group identifier (e.g., the tag-Id_1 1020). In one example, the second timing advance value may be a second time value (e.g., a second time value expressed in a suitable unit of time, such as milliseconds or microseconds) included in the second timing advance command 1106. In one example, with reference to FIG. 13, the UE 702 may apply the second timing advance (e.g., TA_2) 1320 for the second UL transmission 1114 to the TRP_2 706. The value of the second timing advance (e.g., TA_2) 1320 may be approximately equal to the second timing advance value associated with the second timing advance group identifier (e.g., the tag-Id_1 1020) and may be approximately equal to twice the propagation delay between the UE 702 and the TRP_2 706.

In another example, as described with reference to FIG. 15, the UE 702 may apply a second timing advance value to the second UL transmission 1514. For example, the UE may determine the second timing advance value for the second UL transmission 1514 by determining a sum of the first timing advance value associated with the timing advance group identifier (e.g., tag-Id 1412) and the timing advance offset value (e.g., 2 (δt)) in the timing advance command 1506 for a timing advance offset to the second UL transmission 1514 to the TRP_2 706. Therefore, the second timing advance value in this example may be expressed as 2t+2 (δt). In one example, the UE 702 may apply the second timing advance (e.g., TA_2) 1720 for the second UL transmission 1514 to the TRP_2 706 as shown in FIG. 17. The value of the second timing advance (TA_2) 1720 may be expressed as 2t+2 (δt).

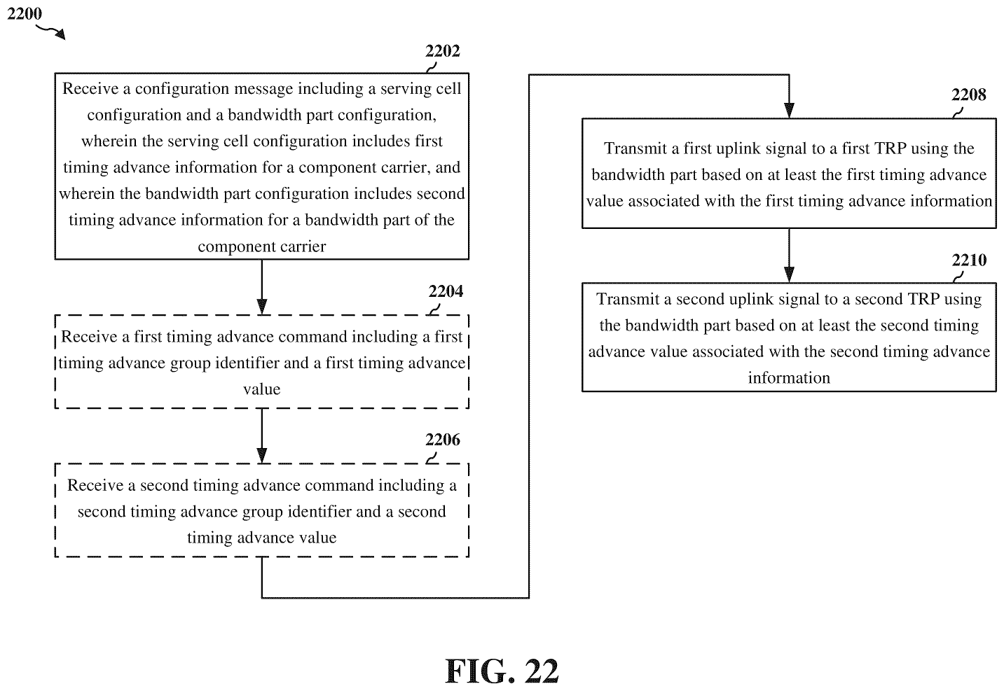

FIG. 22 is a flowchart 2200 of a method of wireless communication. The method may be performed by a UE (e.g., the UE 104, 702; the apparatus 2602/2602′; the processing system 2714, which may include the memory 360 and which may be the entire UE 104, 702 or a component of the UE 104, 702, such as the TX processor 368, the RX processor 356, and/or the controller/processor 359).

At 2202, the UE receives a configuration message including a serving cell configuration and a bandwidth part configuration, wherein the serving cell configuration includes first timing advance information for a component carrier, and wherein the bandwidth part configuration includes second timing advance information for a bandwidth part of the component carrier. In FIG. 22, operations indicated with dashed lines represent optional operations.

In some examples, the configuration message may be the configuration message 1102 described with reference to FIG. 11 in the first example timing advance configuration. In some examples, the configuration message 1102 may include a configuration for a serving cell (e.g., a ServingCellConfig IE) that includes at least a parameter (e.g., tag-id_0) for indicating first timing advance information for the serving cell, such as a TAG for the serving cell. The configuration message 1102 may further include an uplink BWP IE (e.g., a BWP-Uplink IE) for configuring an uplink BWP of a serving cell (e.g., a component carrier). In some examples, the BWP-Uplink IE may include at least a parameter (herein referred to as tag-Id_1) for configuring second timing advance information for a bandwidth part, such as a TAG for the BWP.

In some examples, the bandwidth part configuration enables multi-TRP operation for the bandwidth part. For example, the configuration for the second BWP 1016 may include an mDCI mTRP configuration 1018 to support mDCI mTRP operation in the uplink where different CORESET pool index values may be configured in the corresponding BWP for the DL.

In some examples, the bandwidth part is one of a plurality of bandwidth parts associated with the component carrier, and wherein the second timing advance information for the bandwidth part is not associated with one or more different bandwidth parts of the plurality of bandwidth parts. In some examples, the one or more different bandwidth parts of the plurality of bandwidth parts are configured for single TRP operation. For example, the configuration for the first BWP 1014 may include a single TRP configuration 1017 to support single TRP operation in the uplink.

At 2204, the UE receives a first timing advance command including a first timing advance group identifier and a first timing advance value. For example, the UE 702 may receive the first timing advance command 1104, which may include a first timing advance group identifier (e.g., the tag-Id_0 1012) and a first timing advance value associated with the first timing advance group identifier. The first timing advance value in the first timing advance command 1104 may be a first time value expressed in a suitable unit of time, such as milliseconds or microseconds. In some examples, the first timing advance value in the first timing advance command 1104 may be information corresponding to a first time value, such as an index value TA, where TA=(0, 1, 2, . . . , 63). The first timing advance value associated with the first timing advance group identifier (e.g., the tag-Id_0 1012) and may be approximately equal to twice the propagation delay between the UE 702 and the TRP_1 704.

At 2206, the UE receives a second timing advance command including a second timing advance group identifier and a second timing advance value.

For example, the UE 702 may receive the second timing advance command 1106, which may include a second timing advance group identifier (e.g., the tag-Id_1 1020) and a second timing advance value associated with the second timing advance group identifier. The second timing advance value in the second timing advance command 1104 may be a second time value expressed in a suitable unit of time, such as milliseconds or microseconds. In some examples, the second timing advance value in the second timing advance command 1106 may be information corresponding to a second time value, such as an index value TA, where TA=(0, 1, 2, . . . , 63). The second timing advance value associated with the second timing advance group identifier (e.g., the tag-Id_1 1020) and may be approximately equal to twice the propagation delay between the UE 702 and the TRP_2 706.

At 2208, the UE transmits a first uplink signal to a first TRP using the bandwidth part based on at least the first timing advance value associated with the first timing advance information.

In one example, as described with reference to FIG. 11, the UE 702 may apply a first timing advance value to the first UL transmission 1110 to the TRP_1 704 in a BWP of a component carrier configured for mDCI mTRP operation, such as the second BWP 1016 shown in FIG. 10. For example, the first timing advance information may be the first timing advance group identifier (e.g., the tag-Id_0 1012). In one example, the first timing advance value may be a first time value (e.g., a first time value expressed in a suitable unit of time, such as milliseconds or microseconds) included in the first timing advance command 1104. In one example, with reference to FIG. 13, the UE 702 may apply the first timing advance (e.g., TA_1) 1310 for the first UL transmission 1110 to the TRP_1 704. The value of the first timing advance (e.g., TA_1) 1310 may be approximately equal to the first timing advance value associated with the first timing advance group identifier (e.g., the tag-Id_0 1012).

At 2210, the UE transmits a second uplink signal to a second TRP using the bandwidth part based on at least the second timing advance value associated with the second timing advance information.

In one example, as described with reference to FIG. 11, the UE 702 may apply a second timing advance value to the second UL transmission 1114 using a BWP of a component carrier configured for mDCI mTRP operation, such as the second BWP 1016 shown in FIG. 10. For example, the second timing advance information may be the second timing advance group identifier (e.g., the tag-Id_1 1020). In one example, the second timing advance value may be a second time value (e.g., a second time value expressed in a suitable unit of time, such as milliseconds or microseconds) included in the second timing advance command 1106. In one example, with reference to FIG. 13, the UE 702 may apply the second timing advance (e.g., TA_2) 1320 for the second UL transmission 1114 to the TRP_2 706. The value of the second timing advance (e.g., TA_2) 1320 may be approximately equal to the second timing advance value associated with the second timing advance group identifier (e.g., the tag-Id_1 1020).

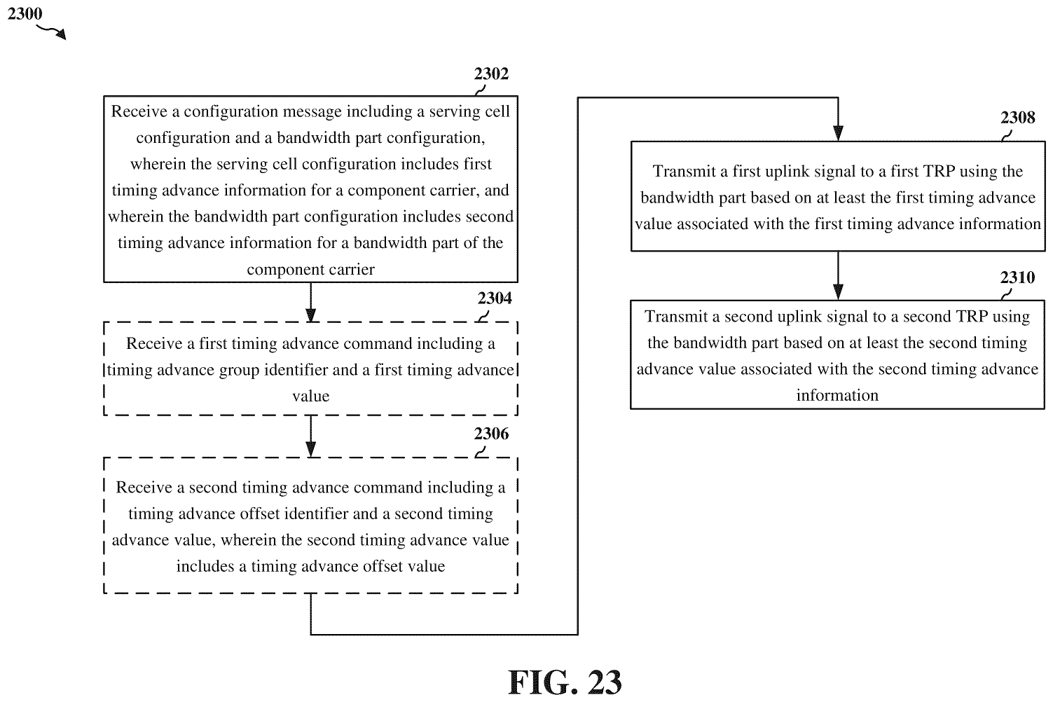

FIG. 23 is a flowchart 2300 of a method of wireless communication. The method may be performed by a UE (e.g., the UE 104, 702; the apparatus 2602/2602′; the processing system 2714, which may include the memory 360 and which may be the entire UE 104, 702 or a component of the UE 104, 702, such as the TX processor 368, the RX processor 356, and/or the controller/processor 359). In FIG. 23, operations indicated with dashed lines represent optional operations.

At 2302, the UE receives a configuration message including a serving cell configuration and a bandwidth part configuration, wherein the serving cell configuration includes first timing advance information for a component carrier, and wherein the bandwidth part configuration includes second timing advance information for a bandwidth part of the component carrier.

In some examples, the configuration message may be the configuration message 1502 described with reference to FIG. 15 in the second example timing advance configuration. In some examples, the configuration message 1502 may include a configuration for a serving cell (e.g., a ServingCellConfig IE) that includes at least a parameter (e.g., tag-id) for indicating first timing advance information for the serving cell, such as a TAG for the serving cell. The configuration message 1502 may further include an uplink BWP IE (e.g., a BWP-Uplink IE) for configuring an uplink BWP of a serving cell (e.g., a component carrier). In some examples, the BWP-Uplink IE may include at least a parameter (herein referred to as TAoffsetId) for configuring second timing advance information for a BWP, such as a timing advance offset TAG for the BWP.

In some examples, the bandwidth part configuration enables multi-TRP operation for the bandwidth part. For example, the configuration for the second BWP 1416 may include an mDCI mTRP configuration 1418 to support mDCI mTRP operation in the uplink where different CORESET pool index values may be configured in the corresponding BWP for the DL.

In some examples, the bandwidth part is one of a plurality of bandwidth parts associated with the component carrier, and wherein the second timing advance information for the bandwidth part is not associated with one or more different bandwidth parts of the plurality of bandwidth parts. In some examples, the one or more different bandwidth parts of the plurality of bandwidth parts are configured for single TRP operation. For example, the configuration for the first BWP 1014 may include a single TRP configuration 1417 to support single TRP operation in the uplink.

At 2304, the UE receives a first timing advance command including a timing advance group identifier and a first timing advance value. For example, the UE 702 may receive the timing advance command 1504 for a first timing advance group (TAG), which may include a timing advance group identifier (e.g., the tag-Id 1412) and a first timing advance value associated with the first timing advance group identifier. The first timing advance value in the first timing advance command 1504 may be a first time value expressed in a suitable unit of time, such as milliseconds or microseconds. In some examples, the first timing advance value in the timing advance command 1504 may be information corresponding to a first time value, such as an index value TA, where TA=(0, 1, 2, . . . , 63). The first timing advance value associated with the timing advance group identifier (e.g., the tag-Id 1412) and may be approximately equal to twice the propagation delay between the UE 702 and the TRP_1 704.

At 2306, the UE receives a second timing advance command including a timing advance offset identifier and a second timing advance value, wherein the second timing advance value includes a timing advance offset value. For example, the UE 702 may receive the timing advance command 1506 for a timing advance offset, which may include a timing advance offset identifier and a second timing advance value associated with the timing advance offset identifier. In one example, the second timing advance value may be a timing advance offset value represented as 2 (δt). In one example, the timing advance offset identifier may be the TAoffsetId 1420 configured for a BWP (e.g., the second BWP 1416) of the component carrier 1410.

At 2308, the UE transmits a first uplink signal to a first TRP using the bandwidth part based on at least the first timing advance value associated with the first timing advance information.

In another example, as described with reference to FIG. 15, the UE 702 may apply a first timing advance value to the first UL transmission 1510 to the TRP_1 704 in a BWP of a component carrier configured for mDCI mTRP operation, such as the second BWP 1416 shown in FIG. 14. For example, the first timing advance information may include the timing advance group identifier (e.g., the tag-Id 1412) configured for the component carrier 1410. In one example, the first timing advance value may be a first time value (e.g., a first time value expressed in a suitable unit of time, such as milliseconds or microseconds) included in the timing advance command 1504. In one example, with reference to FIG. 17, the UE 702 may apply the first timing advance (e.g., TA_1) 1710 for the first UL transmission 1510 to the TRP_1 704. The value of the first timing advance (e.g., TA_1) 1710 may be approximately equal to the first timing advance value associated with the timing advance group identifier (e.g., tag-Id 1412) and may be approximately equal to twice the propagation delay between the UE 702 and the TRP_1 704. For example, the value of the first timing advance (e.g., TA_1) 1710 may be approximately equal to 2t.

At 2310, the UE transmits a second uplink signal to a second TRP using the bandwidth part based on at least the second timing advance value associated with the second timing advance information.

For example, as described with reference to FIG. 15, the UE 702 may apply a second timing advance value to the second UL transmission 1514. For example, the UE may determine the second timing advance value for the second UL transmission 1514 by determining a sum of the first timing advance value associated with the timing advance group identifier (e.g., tag-Id 1412) and the timing advance offset value (e.g., 2 (δt)) in the timing advance command 1506 for a timing advance offset to the second UL transmission 1514 to the TRP_2 706. Therefore, the second timing advance value in this example may be expressed as 2t+2 (δt). In one example, the UE 702 may apply the second timing advance (e.g., TA_2) 1720 for the second UL transmission 1514 to the TRP_2 706 as shown in FIG. 17. The value of the second timing advance (TA_2) 1720 may be expressed as 2t+2 (δt).

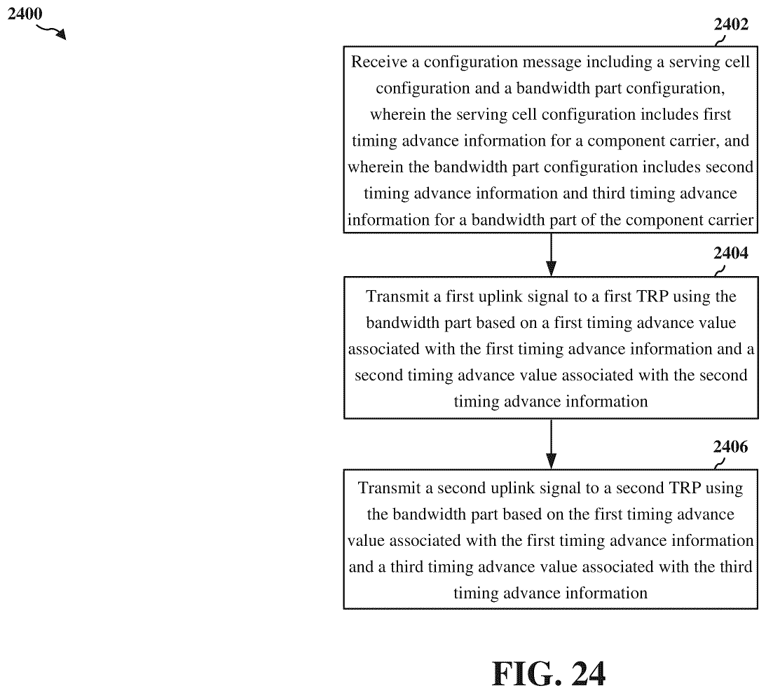

FIG. 24 is a flowchart 2400 of a method of wireless communication. The method may be performed by a UE (e.g., the UE 104, 702; the apparatus 2602/2602′; the processing system 2714, which may include the memory 360 and which may be the entire UE 104, 702 or a component of the UE 104, 702, such as the TX processor 368, the RX processor 356, and/or the controller/processor 359).

At 2402, the UE receives a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier.

In some examples, the configuration message may be the configuration message 1902 described with reference to FIG. 19 in the third example timing advance configuration. In some examples, the configuration message 1902 may include a configuration for a serving cell (e.g., a ServingCellConfig IE) that includes at least a parameter (e.g., tag-id) for indicating first timing advance information for the serving cell, such as a TAG for the serving cell. The configuration message 1902 may further include an uplink BWP IE (e.g., a BWP-Uplink IE) for configuring an uplink BWP of a serving cell (e.g., a component carrier). In some examples, the BWP-Uplink IE may include at least a parameter (herein referred to as TAoffsetId_0) for configuring second timing advance information for a bandwidth part, such as a first timing advance offset TAG for the BWP, and a parameter (herein referred to as TAoffsetId_1) for configuring third timing advance information for a bandwidth part, such as a second timing advance offset TAG for the BWP.

For example, with reference to FIG. 18, the first timing advance information for the component carrier may include the Tag-id 1812, the second timing advance information for a bandwidth part (e.g., the second BWP 1816) may be the first timing advance offset identifier TAoffsetId_0 1820, and the third timing advance information for the bandwidth part (e.g., the second BWP 1816) may be the second timing advance offset identifier TAoffsetId_1 1822.

In some examples, the bandwidth part configuration enables multi-TRP operation for the bandwidth part. For example, the configuration for the second BWP 1816 may include an mDCI mTRP configuration 1018 to support mDCI mTRP operation in the uplink where different CORESET pool index values may be configured in the corresponding BWP for the DL.

In some examples, the bandwidth part is one of a plurality of bandwidth parts associated with the component carrier, and wherein the second timing advance information for the bandwidth part is not associated with one or more different bandwidth parts of the plurality of bandwidth parts. In some examples, the one or more different bandwidth parts of the plurality of bandwidth parts are configured for single TRP operation. For example, the configuration for the first BWP 1814 may include a single TRP configuration 1817 to support single TRP operation in the uplink.

At 2404, the UE transmits a first uplink signal to a first TRP using the bandwidth part based on a first timing advance value associated with the first timing advance information and a second timing advance value associated with the second timing advance information.

For example, the UE 702 may determine the sum of the first timing advance value (e.g., 2t) associated with the Tag-Id 1812 and the second timing advance value (e.g., 2 (δt₁) associated with the first timing advance offset identifier (TAoffsetId_0) 1820). The sum (e.g., 2t+2 (δt₁)) may be approximately equal to twice the propagation delay between the UE 702 and the TRP_1 704. The UE 702 may apply the sum (e.g., 2t+2 (δt₁)) as a first timing advance to the first UL transmission 1912 to the TRP_1 704. For example, the UL timing 2006 shows the UE 702 applying a first timing advance (e.g., TA_1) 2010 for the first UL transmission 1912 to the TRP_1 704, where the value of the first timing advance (e.g., TA_1) 2010 is 2t+2 (δt₁).

At 2406, the UE transmits a second uplink signal to a second TRP using the bandwidth part based on the first timing advance value associated with the first timing advance information and a third timing advance value associated with the third timing advance information.

For example, the UE 702 may determine the sum of the first timing advance value (e.g., 2t) associated with the Tag-Id 1812 and the third timing advance value (e.g., 2 (δt₂) associated with the second timing advance offset identifier (TAoffsetId_1) 1822). The sum (e.g., 2t+2 (δt₂)) may be approximately equal to twice the propagation delay between the UE 702 and the TRP_2 706. The UE 702 may apply the sum (e.g., 2t+2 (δt₂)) as a second timing advance to the second UL transmission 1916 to the TRP_2 706. For example, the UL timing 2016 shows the UE 702 applying a second timing advance (e.g., TA_2) 2020 for the second UL transmission 1916 to the TRP_2 706, where the value of the second timing advance (e.g., TA_2) 2020 is 2t+2 (δt₂).

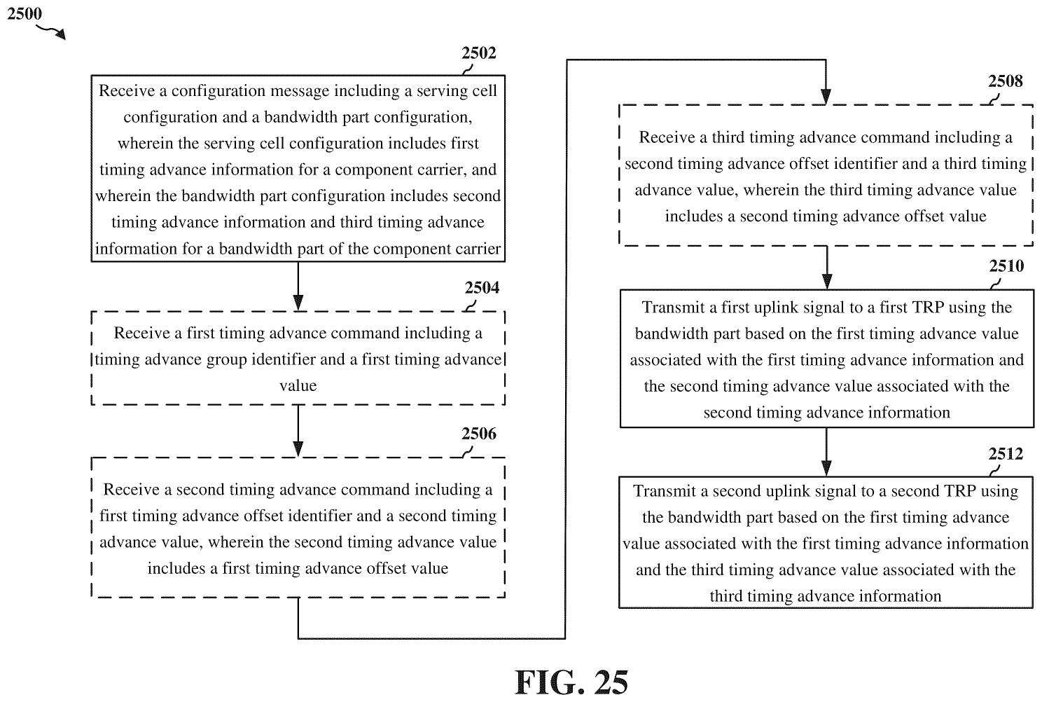

FIG. 25 is a flowchart 2500 of a method of wireless communication. The method may be performed by a UE (e.g., the UE 104, 702; the apparatus 2602/2602′; the processing system 2714, which may include the memory 360 and which may be the entire UE 104, 702 or a component of the UE 104, 702, such as the TX processor 368, the RX processor 356, and/or the controller/processor 359). In FIG. 25, operations indicated with dashed lines represent optional operations. At 2502, the UE receives a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier.

In some examples, the configuration message may be the configuration message 1902 described with reference to FIG. 19 in the third example timing advance configuration. In some examples, the configuration message 1902 may include a configuration for a serving cell (e.g., a ServingCellConfig IE) that includes at least a parameter (e.g., tag-id) for indicating first timing advance information for the serving cell, such as a TAG for the serving cell. The configuration message 1902 may further include an uplink BWP IE (e.g., a BWP-Uplink IE) for configuring an uplink BWP of a serving cell (e.g., a component carrier). In some examples, the BWP-Uplink IE may include at least a parameter (herein referred to as TAoffsetId_0) for configuring second timing advance information for a bandwidth part, such as a first timing advance offset TAG for the BWP, and a parameter (herein referred to as TAoffsetId_1) for configuring third timing advance information for a bandwidth part, such as a second timing advance offset TAG for the BWP.

For example, with reference to FIG. 18, the first timing advance information for the component carrier may include the Tag-id 1812, the second timing advance information for a bandwidth part (e.g., the second BWP 1816) may include the first timing advance offset identifier TAoffsetId_0 1820, and the third timing advance information for the bandwidth part (e.g., the second BWP 1816) may include the second timing advance offset identifier TAoffsetId_1 1822.

In some examples, the bandwidth part configuration enables multi-TRP operation for the bandwidth part. For example, the configuration for the second BWP 1816 may include an mDCI mTRP configuration 1818 to support mDCI mTRP operation in the uplink where different CORESET pool index values may be configured in the corresponding BWP for the DL.

In some examples, the bandwidth part is one of a plurality of bandwidth parts associated with the component carrier, and wherein the second timing advance information for the bandwidth part is not associated with one or more different bandwidth parts of the plurality of bandwidth parts. In some examples, the one or more different bandwidth parts of the plurality of bandwidth parts are configured for single TRP operation. For example, the configuration for the first BWP 1814 may include a single TRP configuration 1817 to support single TRP operation in the uplink.

At 2504, the UE receives a first timing advance command including a timing advance group identifier and a first timing advance value. For example, with reference to FIG. 19, the UE 702 may receive a timing advance command 1904 for a timing advance group (TAG). The timing advance command 1904 for the TAG may include the timing advance group identifier (e.g., the tag-Id 1812) configured for the component carrier 1810. In one example, the first timing advance value in the timing advance command 1904 may be a time value expressed in a suitable unit of time, such as milliseconds or microseconds. For example, the first timing advance value in the timing advance command 1904 for a TAG may be 2t, where t represents a time value expressed in a suitable unit of time, such as milliseconds (ms) or microseconds (μs).

At 2506, the UE receives a second timing advance command including a first timing advance offset identifier and a second timing advance value, wherein the second timing advance value includes a first timing advance offset value. For example, the UE 702 may receive a first timing advance command 1906 for a first timing advance offset, which may include a first timing advance offset identifier (e.g., TAoffsetId_0 1820) and a second timing advance value associated with the first timing advance offset identifier. The second timing advance value associated with the first timing advance offset identifier may be a first timing advance offset value represented as 2 (δt₁), where δt₁ may be a time value expressed in a suitable unit of time, such as milliseconds or microseconds.

At 2508, the UE receives a third timing advance command including a second timing advance offset identifier and a third timing advance value, wherein the third timing advance value includes a second timing advance offset value, and wherein the second uplink signal is transmitted to the second TRP based on a sum of the first timing advance value and the third timing advance value.

For example, the UE 702 may receive a second timing advance command 1908 for a second timing advance offset, which may include a second timing advance offset identifier (e.g., TAoffsetId_1 1822) and a third timing advance value associated with the second timing advance offset identifier. The third timing advance value associated with the second timing advance offset identifier may be a second timing advance offset value represented as 2 (δt₂), where δt₂ may be a time value expressed in a suitable unit of time, such as milliseconds or microseconds.

At 2510, the UE transmits a first uplink signal to a first TRP using the bandwidth part based on the first timing advance value associated with the first timing advance information and a second timing advance value associated with the second timing advance information.

For example, the UE 702 may determine the sum of the first timing advance value (e.g., 2t) associated with the Tag-Id 1812 and the second timing advance value (e.g., 2 (δt₁) associated with the first timing advance offset identifier (TAoffsetId_0) 1820). The sum (e.g., 2t+2 (δt₁)) may be approximately equal to twice the propagation delay between the UE 702 and the TRP_1 704. The UE 702 may apply the sum (e.g., 2t+2 (δt₁)) as a first timing advance to the first UL transmission 1912 to the TRP_1 704. For example, the UL timing 2006 shows the UE 702 applying a first timing advance (e.g., TA_1) 2010 for the first UL transmission 1912 to the TRP_1 704, where the value of the first timing advance (e.g., TA_1) 2010 is 2t+2 (δt₁).

At 2512, the UE transmits a second uplink signal to a second TRP using the bandwidth part based on the first timing advance value associated with the first timing advance information and the third timing advance value associated with the third timing advance information.

For example, the UE 702 may determine the sum of the first timing advance value (e.g., 2t) associated with the Tag-Id 1812 and the third timing advance value (e.g., 2 (δt₂) associated with the second timing advance offset identifier (TAoffsetId_1) 1822). The sum (e.g., 2t+2 (δt₂)) may be approximately equal to twice the propagation delay between the UE 702 and the TRP_2 706. The UE 702 may apply the sum (e.g., 2t+2 (δt₂)) as a second timing advance to the second UL transmission 1916 to the TRP_2 706. For example, the UL timing 2016 shows the UE 702 applying a second timing advance (e.g., TA_2) 2020 for the second UL transmission 1916 to the TRP_2 706, where the value of the second timing advance (e.g., TA_2) 2020 is 2t+2 (δt₂).

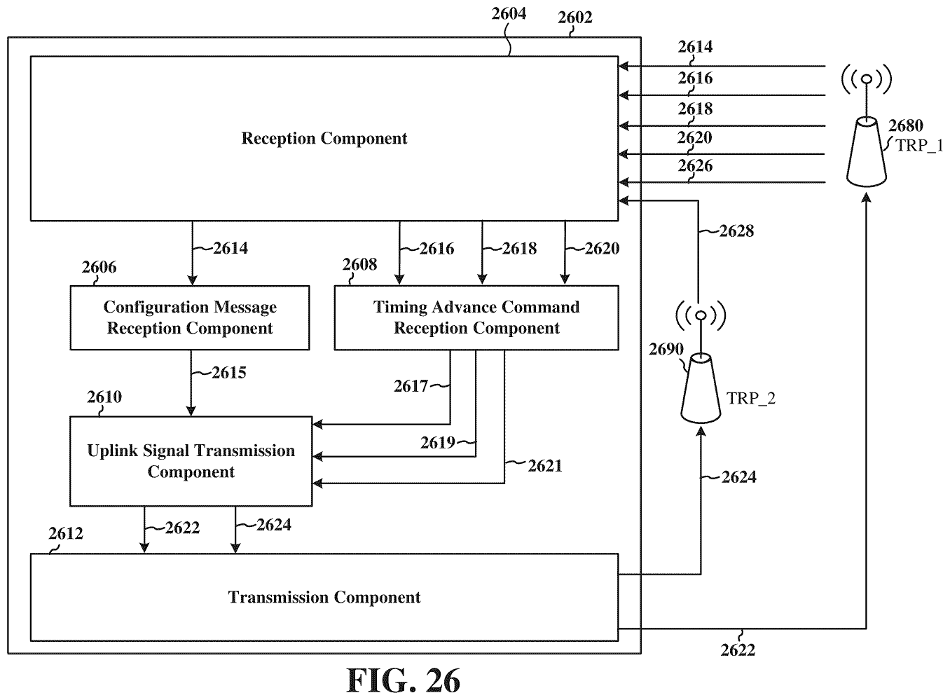

FIG. 26 is a conceptual data flow diagram 2600 illustrating the data flow between different means/components in an example apparatus 2602. The apparatus may be a UE. The apparatus includes a reception component 2604 that receives, from a first TRP (TRP_1) 2680, a configuration message 2614. In one example, the configuration message 2614 may include a serving cell configuration and a bandwidth part configuration, wherein the serving cell configuration includes first timing advance information for a component carrier, and wherein the bandwidth part configuration includes second timing advance information for a bandwidth part of the component carrier. In another example, the configuration message 2614 may include a serving cell configuration and a bandwidth part configuration, wherein the serving cell configuration includes first timing advance information for a component carrier, and wherein the bandwidth part configuration includes second timing advance information and third timing advance information for a bandwidth part of the component carrier.

The reception component 2604 further receives a first timing advance command 2616. For example, the first timing advance command 2616 may include a first timing advance group identifier (e.g., the Tag-Id_0 1012) or a timing advance group identifier (e.g., the Tag-Id 1412 or the Tag-Id 1812) and a first timing advance value.

The reception component 2604 further receives a second timing advance command 2618. In one example, the second timing advance command 2618 may include a second timing advance group identifier and a second timing advance value. In another example, the second timing advance command 2618 may include a timing advance offset identifier and a second timing advance value, where the second timing advance value includes a timing advance offset value. In yet another example, the second timing advance command 2618 may include a first timing advance offset identifier and a second timing advance value, where the second timing advance value includes a first timing advance offset value.

The reception component 2604 further receives a third timing advance command 2620. In one example, the third timing advance command 2620 may include a second timing advance offset identifier and a third timing advance value, where the third timing advance value includes a second timing advance offset value.

The reception component 2604 further receives a first DL signal 2626 (also referred to as a DL transmission) from the TRP_1 2680 and a second DL signal 2628 from a second TRP (TRP_2) 2690.

The apparatus further includes a configuration message reception component 2606 that receives the configuration message 2614 and provides configuration information 2615, which may include a serving cell configuration and a BWP configuration.

The apparatus further includes a timing advance command reception component 2608 that receives the first timing advance command 2616 and provides a first timing advance value 2617 of the first timing advance command 2616. The timing advance command reception component 2608 further receives the second timing advance command 2618 and provides a second timing advance value 2619 of the second timing advance command 2618. The timing advance command reception component 2608 further receives the third timing advance command 2620 and provides a third timing advance value 2621 of the third timing advance command 2620.

The apparatus further includes an uplink signal transmission component 2610 that transmits (e.g., via the transmission component 2612) a first uplink signal 2622 to the TRP_1 2680. In one example, the uplink signal transmission component 2610 transmits (e.g., via the transmission component 2612) the first uplink signal 2622 using the bandwidth part based on at least a first timing advance value (e.g., a first timing advance value 2617) associated with the first timing advance information. In another example, the uplink signal transmission component 2610 transmits (e.g., via the transmission component 2612) the first uplink signal 2622 using the bandwidth part based on a first timing advance value (e.g., a first timing advance value 2617) associated with the first timing advance information and a second timing advance value (e.g., a second timing advance value 2619) associated with the second timing advance information.

The uplink signal transmission component 2610 further transmits (e.g., via the transmission component 2612) a second uplink signal 2624 to the TRP_2 2690. In one example, the uplink signal transmission component 2610 transmits (e.g., via the transmission component 2612) the second uplink signal 2624 using the bandwidth part based on at least a second timing advance value (e.g., the second timing advance value 2619) associated with the second timing advance information. In another example, the uplink signal transmission component 2610 transmits (e.g., via the transmission component 2612) the second uplink signal 2624 using the bandwidth part based on the first timing advance value (e.g., a first timing advance value 2617) associated with the first timing advance information and a third timing advance value (e.g., the third timing advance value 2621) associated with the third timing advance information.

The apparatus further includes a transmission component 2612 that transmits uplink signals to the TRP_1 2680 and the TRP_2 2690, such as the first uplink signal 2622 and the second uplink signal 2624.

The apparatus may include additional components that perform each of the blocks of the algorithm in the aforementioned flowcharts of FIGS. 21-25. As such, each block in the aforementioned flowcharts of FIGS. 21-25 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

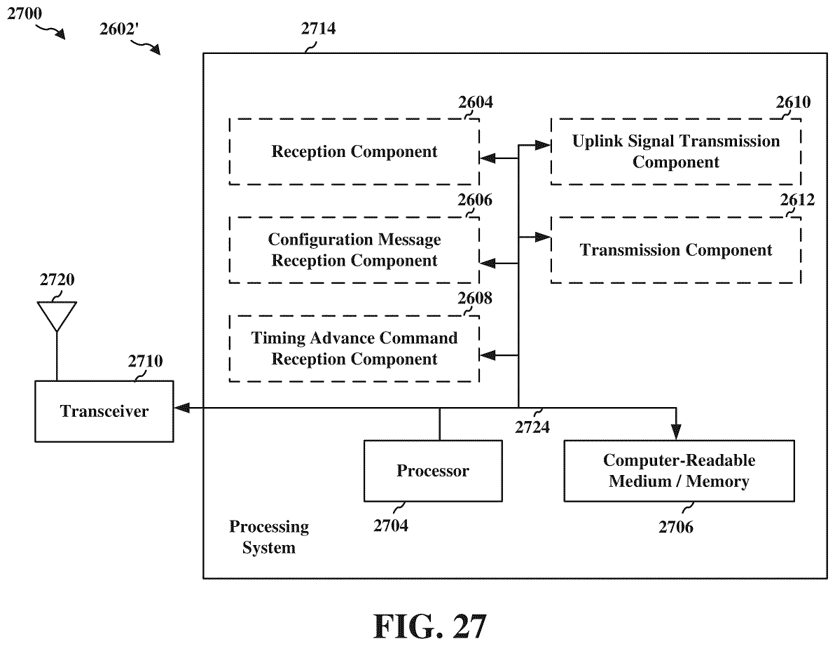

FIG. 27 is a diagram 2700 illustrating an example of a hardware implementation for an apparatus 2602′ employing a processing system 2714. The processing system 2714 may be implemented with a bus architecture, represented generally by the bus 2724. The bus 2724 may include any number of interconnecting buses and bridges depending on the specific application of the processing system 2714 and the overall design constraints. The bus 2724 links together various circuits including one or more processors and/or hardware components, represented by the processor 2704, the components 2604, 2606, 2608, 2610, 2612 and the computer-readable medium/memory 2706. The bus 2724 may also link various other circuits such as timing sources, peripherals, voltage regulators, and power management circuits, which are well known in the art, and therefore, will not be described any further.

The processing system 2714 may be coupled to a transceiver 2710. The transceiver 2710 is coupled to one or more antennas 2720. In some examples, the one or more antennas 2720 may include multiple antenna panels. The transceiver 2710 provides a means for communicating with various other apparatus over a transmission medium. The transceiver 2710 receives a signal from the one or more antennas 2720, extracts information from the received signal, and provides the extracted information to the processing system 2714, specifically the reception component 2604. In addition, the transceiver 2710 receives information from the processing system 2714, specifically the transmission component 2612, and based on the received information, generates a signal to be applied to the one or more antennas 2720. The processing system 2714 includes a processor 2704 coupled to a computer-readable medium/memory 2706. The processor 2704 is responsible for general processing, including the execution of software stored on the computer-readable medium/memory 2706. The software, when executed by the processor 2704, causes the processing system 2714 to perform the various functions described supra for any particular apparatus. The computer-readable medium/memory 2706 may also be used for storing data that is manipulated by the processor 2704 when executing software. The processing system 2714 further includes at least one of the components 2604, 2606, 2608, 2610, 2612. The components may be software components running in the processor 2704, resident/stored in the computer readable medium/memory 2706, one or more hardware components coupled to the processor 2704, or some combination thereof. The processing system 2714 may be a component of the UE 350 and may include the memory 360 and/or at least one of the TX processor 368, the RX processor 356, and the controller/processor 359. Alternatively, the processing system 2714 may be the entire UE (e.g., see 350 of FIG. 3).

In one configuration, the apparatus 2602/2602′ for wireless communication includes means for receiving a configuration message including a serving cell configuration and a bandwidth part configuration, wherein the serving cell configuration includes first timing advance information for a component carrier, and wherein the bandwidth part configuration includes second timing advance information for a bandwidth part of the component carrier, means for transmitting a first uplink signal to a first TRP using the bandwidth part based on at least a first timing advance value associated with the first timing advance information, means for transmitting a second uplink signal to a second TRP using the bandwidth part based on at least a second timing advance value associated with the second timing advance information, means for receiving a first timing advance command including a first timing advance group identifier and the first timing advance value, means for receiving a second timing advance command including the second timing advance group identifier and the second timing advance value, means for receiving a second timing advance command including the timing advance offset identifier and the second timing advance value, wherein the second timing advance value includes a timing advance offset value, and wherein the second uplink signal is transmitted to the second TRP based on a sum of the first timing advance value and the second timing advance value, means for receiving a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier, means for transmitting a first uplink signal to a first TRP using the bandwidth part based on a first timing advance value associated with the first timing advance information and a second timing advance value associated with the second timing advance information, means for transmitting a second uplink signal to a second TRP using the bandwidth part based on the first timing advance value associated with the first timing advance information and a third timing advance value associated with the third timing advance information, means for receiving a first timing advance command including the timing advance group identifier and the first timing advance value, means for receiving a second timing advance command including the first timing advance offset identifier and the second timing advance value, wherein the second timing advance value includes a first timing advance offset value, and wherein the first uplink signal is transmitted to the first TRP based on a sum of the first timing advance value and the second timing advance value, means for receiving a third timing advance command including the second timing advance offset identifier and the third timing advance value, wherein the third timing advance value includes a second timing advance offset value, and wherein the second uplink signal is transmitted to the second TRP based on a sum of the first timing advance value and the third timing advance value.

The aforementioned means may be one or more of the aforementioned components of the apparatus 2602 and/or the processing system 2714 of the apparatus 2602′ configured to perform the functions recited by the aforementioned means. As described supra, the processing system 2714 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

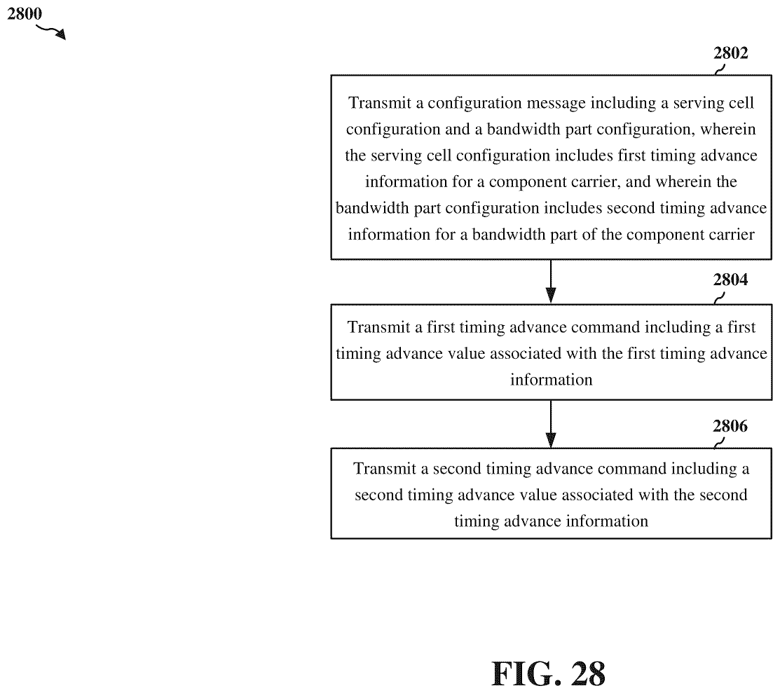

FIG. 28 is a flowchart 2800 of a method of wireless communication. The method may be performed by a TRP (e.g., TRP_1 704; the apparatus 3002/3002′; the processing system 3114, which may include the memory 376 and which may be the entire TRP or a component of the TRP, such as the TX processor 316, the RX processor 370, and/or the controller/processor 375).

At 2802, the TRP transmits a configuration message including a serving cell configuration and a bandwidth part configuration, wherein the serving cell configuration includes first timing advance information for a component carrier, and wherein the bandwidth part configuration includes second timing advance information for a bandwidth part of the component carrier.

In some examples, the configuration message may be the configuration message 1102 described with reference to FIG. 11 in the first example timing advance configuration. In some examples, the configuration message 1102 may include a configuration for a serving cell (e.g., a ServingCellConfig IE) that includes at least a parameter (e.g., tag-id_0) for indicating first timing advance information for the serving cell, such as a TAG for the serving cell. The configuration message 1102 may further include an uplink BWP IE (e.g., a BWP-Uplink IE) for configuring an uplink BWP of a serving cell (e.g., a component carrier). In some examples, the BWP-Uplink IE may include at least a parameter (herein referred to as tag-Id_1) for configuring second timing advance information for a bandwidth part, such as a TAG for the BWP.

In some examples, the configuration message may be the configuration message 1502 described with reference to FIG. 15 in the second example timing advance configuration. In some examples, the configuration message 1502 may include a configuration for a serving cell (e.g., a ServingCellConfig IE) that includes at least a parameter (e.g., tag-id) for indicating first timing advance information for the serving cell, such as a TAG for the serving cell. The configuration message 1502 may further include an uplink BWP IE (e.g., a BWP-Uplink IE) for configuring an uplink BWP of a serving cell (e.g., a component carrier). In some examples, the BWP-Uplink IE may include at least a parameter (herein referred to as TAoffsetId) for configuring second timing advance information for a BWP, such as a timing advance offset TAG for the BWP.

At 2804, the TRP transmits a first timing advance command including a first timing advance value associated with the first timing advance information.

In one example, the TRP_1 704 may transmit the first timing advance command 1104 described with reference to the first example timing advance configuration, which may include a first timing advance group identifier (e.g., the tag-Id_0 1012) and a first timing advance value associated with the first timing advance group identifier. The first timing advance value in the first timing advance command 1104 may be a first time value expressed in a suitable unit of time, such as milliseconds or microseconds. In some examples, the first timing advance value in the first timing advance command 1104 may be information corresponding to a first time value, such as an index value TA, where TA=(0, 1, 2, . . . , 63). The first timing advance value associated with the first timing advance group identifier (e.g., the tag-Id_0 1012) and may be approximately equal to twice the propagation delay between the UE 702 and the TRP_1 704.

In another example, the TRP_1 704 may transmit the timing advance command 1504 for a first TAG described with reference to the second example timing advance configuration, which may include a timing advance group identifier (e.g., the tag-Id 1412) and a first timing advance value associated with the first timing advance group identifier. The first timing advance value in the first timing advance command 1504 may be a first time value expressed in a suitable unit of time, such as milliseconds or microseconds. In some examples, the first timing advance value in the timing advance command 1504 may be information corresponding to a first time value, such as an index value TA, where TA=(0, 1, 2, . . . , 63). The first timing advance value associated with the timing advance group identifier (e.g., the tag-Id 1412) and may be approximately equal to twice the propagation delay between the UE 702 and the TRP_1 704.

At 2806, the TRP transmits a second timing advance command including a second timing advance value associated with the second timing advance information.

In one example, the TRP_1 704 may transmit the second timing advance command 1106 described with reference to the first example timing advance configuration, which may include a second timing advance group identifier (e.g., the tag-Id_1 1020) and a second timing advance value associated with the second timing advance group identifier. The second timing advance value in the second timing advance command 1104 may be a second time value a suitable unit of time, such as milliseconds or microseconds. In some examples, the second timing advance value in the second timing advance command 1106 may be information corresponding to a second time value, such as an index value TA, where TA=(0, 1, 2, . . . , 63). The second timing advance value associated with the second timing advance group identifier (e.g., the tag-Id_1 1020) and may be approximately equal to twice the propagation delay between the UE 702 and the TRP_2 706.

In another example, the TRP_1 704 may transmit the timing advance command 1506 for a timing advance offset described with reference to the second example timing advance configuration, which may include a timing advance offset identifier and a second timing advance value associated with the timing advance offset identifier. In one example, the second timing advance value may be a timing advance offset value represented as 2 (δt). In one example, the timing advance offset identifier may be the TAoffsetId 1420 configured for a BWP (e.g., the second BWP 1416) of the component carrier 1410.

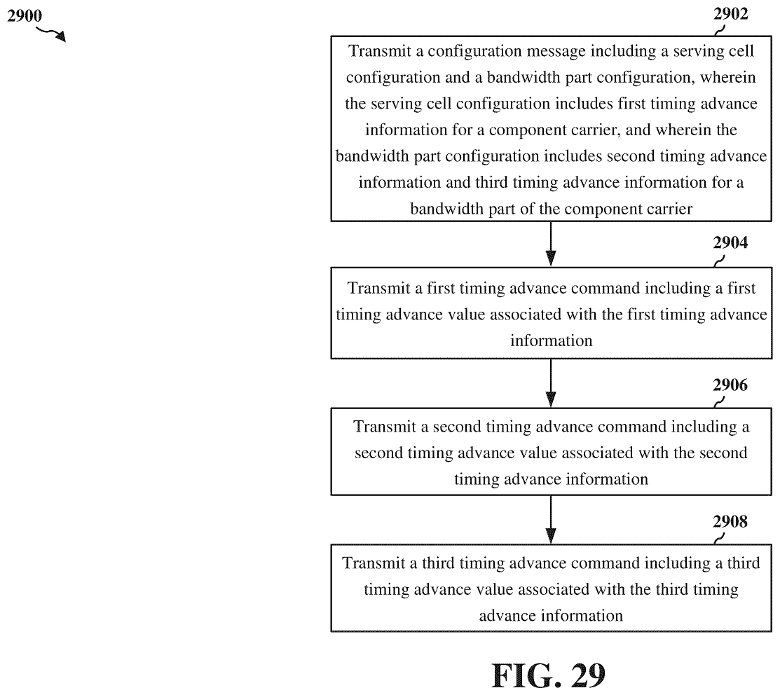

FIG. 29 is a flowchart 2900 of a method of wireless communication. The method may be performed by a TRP (e.g., TRP_1 704; the apparatus 3002/3002′; the processing system 3114, which may include the memory 376 and which may be the entire TRP or a component of the TRP, such as the TX processor 316, the RX processor 370, and/or the controller/processor 375).

At 2902, the TRP transmits a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier.

In some examples, the configuration message may be the configuration message 1902 described with reference to FIG. 19 in the third example timing advance configuration. In some examples, the configuration message 1902 may include a configuration for a serving cell (e.g., a ServingCellConfig IE) that includes at least a parameter (e.g., tag-id) for indicating first timing advance information for the serving cell, such as a TAG for the serving cell. The configuration message 1902 may further include an uplink BWP IE (e.g., a BWP-Uplink IE) for configuring an uplink BWP of a serving cell (e.g., a component carrier). In some examples, the BWP-Uplink IE may include at least a parameter (herein referred to as TAoffsetId_0) for configuring second timing advance information for a bandwidth part, such as a first timing advance offset TAG for the BWP, and a parameter (herein referred to as TAoffsetId_1) for configuring third timing advance information for a bandwidth part, such as a second timing advance offset TAG for the BWP.

At 2904, the TRP transmits a first timing advance command including a first timing advance value associated with the first timing advance information.

For example, with reference to FIG. 19, the TRP_1 704 may transmit the timing advance command 1904 for a timing advance group (TAG). The timing advance command 1904 for the TAG may include the timing advance group identifier (e.g., the tag-Id 1812) configured for the component carrier 1810. In one example, the first timing advance value in the timing advance command 1904 may be a time value expressed in a suitable unit of time, such as milliseconds or microseconds. For example, the first timing advance value in the timing advance command 1904 for a TAG may be 2t, where t represents a time value expressed in a suitable unit of time, such as milliseconds (ms) or microseconds (μs).

At 2906, the TRP transmits a second timing advance command including a second timing advance value associated with the second timing advance information.

For example, the TRP_1 704 may transmit the first timing advance command 1906 for a first timing advance offset, which may include a first timing advance offset identifier (e.g., TAoffsetId_0 1820) and a second timing advance value associated with the first timing advance offset identifier. The second timing advance value associated with the first timing advance offset identifier may be a first timing advance offset value represented as 2 (δt₁), where δt₁ may be a time value expressed in a suitable unit of time, such as milliseconds or microseconds.

At 2908, the TRP transmits a third timing advance command including a third timing advance value associated with the third timing advance information.

For example, the TRP_1 704 may transmit the second timing advance command 1908 for a second timing advance offset, which may include a second timing advance offset identifier (e.g., TAoffsetId_1 1822) and a third timing advance value associated with the second timing advance offset identifier. The third timing advance value associated with the second timing advance offset identifier may be a second timing advance offset value represented as 2 (δt₂), where δt₂ may be a time value expressed in a suitable unit of time, such as milliseconds or microseconds.

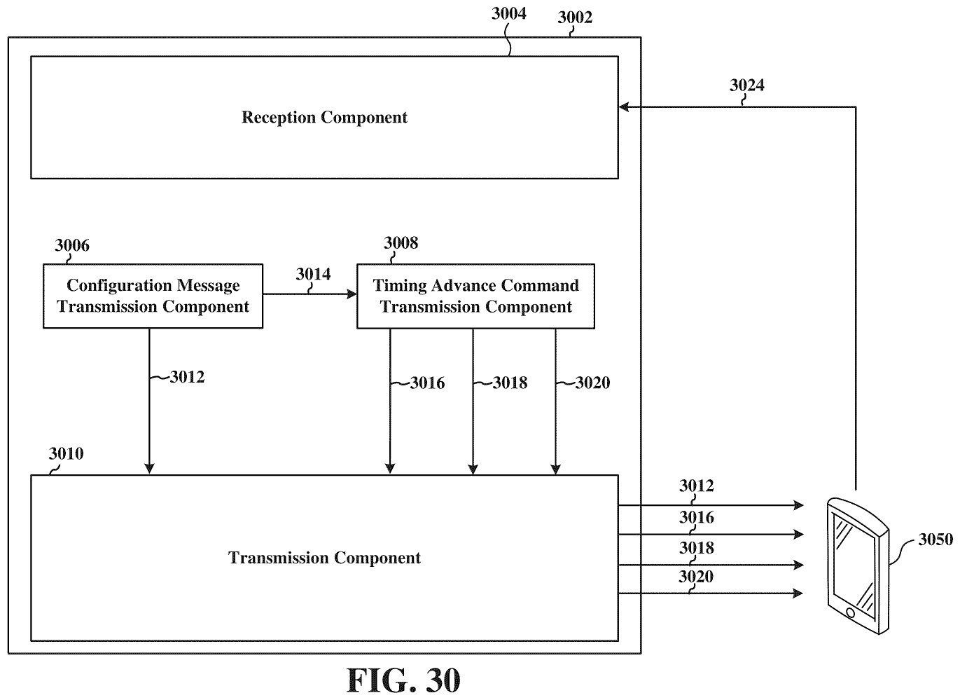

FIG. 30 is a conceptual data flow diagram 3000 illustrating the data flow between different means/components in an example apparatus 3002. The apparatus may be a TRP. The apparatus includes a reception component 3004 that receives an uplink signal 3024 from a UE 3050. The apparatus further includes a configuration message transmission component 3006 that transmits (e.g., via the transmission component 3010) a configuration message 3012 to the UE 3050. In one example, the configuration message 3012 includes a serving cell configuration and a bandwidth part configuration, wherein the serving cell configuration includes first timing advance information for a component carrier, and wherein the bandwidth part configuration includes second timing advance information for a bandwidth part of the component carrier. In another example, the configuration message 3012 includes a serving cell configuration and a bandwidth part configuration, wherein the serving cell configuration includes first timing advance information for a component carrier, and wherein the bandwidth part configuration includes second timing advance information and third timing advance information for a bandwidth part of the component carrier. The configuration message transmission component 3006 provides configuration information 3014 including the first timing advance information and/or the second timing advance information for a component carrier.

The apparatus further includes a timing advance command transmission component 3008 that receives the configuration information 3014 and transmits (e.g., via the transmission component 3010) a first timing advance command 3016, a second timing advance command 3018, and a third timing advance command 3020 to the UE 3050.

For example, the first timing advance command 3016 includes a first timing advance value associated with the first timing advance information. For example, the second timing advance command 3018 includes a second timing advance value associated with the second timing advance information. For example, the third timing advance command 3020 including a third timing advance value associated with the third timing advance information.

The apparatus further includes a transmission component 3010 that transmits downlink signals to the UE 3050, such as the configuration message 3012, the first timing advance command 3016, the second timing advance command 3018, and the third timing advance command 3020.

The apparatus may include additional components that perform each of the blocks of the algorithm in the aforementioned flowcharts of FIGS. 28 and 29. As such, each block in the aforementioned flowcharts of FIGS. 28 and 29 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

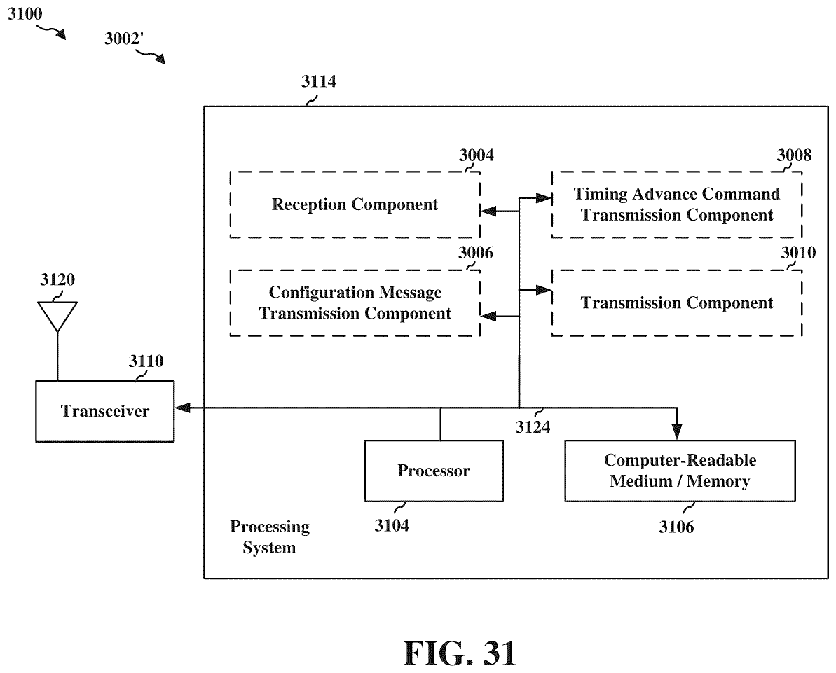

FIG. 31 is a diagram 3100 illustrating an example of a hardware implementation for an apparatus 3002′ employing a processing system 3114. The processing system 3114 may be implemented with a bus architecture, represented generally by the bus 3124. The bus 3124 may include any number of interconnecting buses and bridges depending on the specific application of the processing system 3114 and the overall design constraints. The bus 3124 links together various circuits including one or more processors and/or hardware components, represented by the processor 3104, the components 3004, 3006, 3008, 3010 and the computer-readable medium/memory 3106. The bus 3124 may also link various other circuits such as timing sources, peripherals, voltage regulators, and power management circuits, which are well known in the art, and therefore, will not be described any further.

The processing system 3114 may be coupled to a transceiver 3110. The transceiver 3110 is coupled to one or more antennas 3120. The transceiver 3110 provides a means for communicating with various other apparatus over a transmission medium. The transceiver 3110 receives a signal from the one or more antennas 3120, extracts information from the received signal, and provides the extracted information to the processing system 3114, specifically the reception component 3004. In addition, the transceiver 3110 receives information from the processing system 3114, specifically the transmission component 3010, and based on the received information, generates a signal to be applied to the one or more antennas 3120. The processing system 3114 includes a processor 3104 coupled to a computer-readable medium/memory 3106. The processor 3104 is responsible for general processing, including the execution of software stored on the computer-readable medium/memory 3106. The software, when executed by the processor 3104, causes the processing system 3114 to perform the various functions described supra for any particular apparatus. The computer-readable medium/memory 3106 may also be used for storing data that is manipulated by the processor 3104 when executing software. The processing system 3114 further includes at least one of the components 3004, 3006, 3008, 3010. The components may be software components running in the processor 3104, resident/stored in the computer readable medium/memory 3106, one or more hardware components coupled to the processor 3104, or some combination thereof. The processing system 3114 may be a component of the TRP and may include the memory 376 and/or at least one of the TX processor 316, the RX processor 370, and the controller/processor 375. Alternatively, the processing system 3114 may be the entire TRP (e.g., see 310 of FIG. 3).

In one configuration, the apparatus 3002/3002′ for wireless communication includes means for transmitting a configuration message including a serving cell configuration and a bandwidth part configuration, wherein the serving cell configuration includes first timing advance information for a component carrier, and wherein the bandwidth part configuration includes second timing advance information for a bandwidth part of the component carrier, means for transmitting a first timing advance command including a first timing advance value associated with the first timing advance information, means for transmitting a second timing advance command including a second timing advance value associated with the second timing advance information, means for transmitting a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier, means for transmitting a third timing advance command including a third timing advance value associated with the third timing advance information.

The aforementioned means may be one or more of the aforementioned components of the apparatus 3002 and/or the processing system 3114 of the apparatus 3002′ configured to perform the functions recited by the aforementioned means. As described supra, the processing system 3114 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The timing advance configurations for a UE as described herein may configure additional timing advance information for a specific BWP of a component carrier, where the specific BWP is configured to support mDCI mTRP operation in the uplink. These timing advance configurations allow other BWPs of the component carrier which do not support mDCI mTRP operation (e.g., BWPs configured for single TRP operation) to be independent of any additional timing advance information. This may reduce complexity with respect to the configuration and operation of BWPs configured for single TRP operation.

The following provides an overview of aspects of the present disclosure:

Aspect 1: An apparatus for wireless communication, comprising: a memory; and at least one processor coupled to the memory and configured to: receive a configuration message including a serving cell configuration and a bandwidth part configuration, wherein the serving cell configuration includes first timing advance information for a component carrier, and wherein the bandwidth part configuration includes second timing advance information for a bandwidth part of the component carrier; transmit a first uplink signal to a first transmission reception point (TRP) using the bandwidth part based on at least a first timing advance value associated with the first timing advance information; and transmit a second uplink signal to a second TRP using the bandwidth part based on at least a second timing advance value associated with the second timing advance information.

Aspect 2: The apparatus of aspect 1, wherein the first timing advance information includes a first timing advance group identifier and the second timing advance information includes a second timing advance group identifier, wherein the at least one processor is further configured to: receive a first timing advance command including the first timing advance group identifier and the first timing advance value; and receive a second timing advance command including the second timing advance group identifier and the second timing advance value.

Aspect 3: The apparatus of aspect 1 or 2, wherein the bandwidth part configuration enables multi-TRP operation for the bandwidth part.

Aspect 4: The apparatus of any of aspects 1 through 3, wherein the bandwidth part is one of a plurality of bandwidth parts associated with the component carrier, and wherein the second timing advance information for the bandwidth part is not associated with one or more different bandwidth parts of the plurality of bandwidth parts.

Aspect 5: The apparatus of any of aspects 1 through 4, wherein the one or more different bandwidth parts of the plurality of bandwidth parts are configured for single TRP operation.

Aspect 6: The apparatus of any of aspects 1 and 3 through 5, wherein the first timing advance information includes a timing advance group identifier and the second timing advance information includes a timing advance offset identifier, wherein the at least one processor is further configured to: receive a first timing advance command including the timing advance group identifier and the first timing advance value; and receive a second timing advance command including the timing advance offset identifier and the second timing advance value, wherein the second timing advance value includes a timing advance offset value, and wherein the second uplink signal is transmitted to the second TRP based on a sum of the first timing advance value and the second timing advance value.

Aspect 7: An apparatus for wireless communication, comprising: a memory; and at least one processor coupled to the memory and configured to: receive a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier; transmit a first uplink signal to a first transmission reception point (TRP) using the bandwidth part based on a first timing advance value associated with the first timing advance information and a second timing advance value associated with the second timing advance information; and transmit a second uplink signal to a second TRP using the bandwidth part based on the first timing advance value associated with the first timing advance information and a third timing advance value associated with the third timing advance information.

Aspect 8: The apparatus of aspect 7, wherein the first timing advance information includes a timing advance group identifier, the second timing advance information includes a first timing advance offset identifier, and the third timing advance information includes a second timing advance offset identifier, wherein the at least one processor is further configured to: receive a first timing advance command including the timing advance group identifier and the first timing advance value; receive a second timing advance command including the first timing advance offset identifier and the second timing advance value, wherein the second timing advance value includes a first timing advance offset value, and wherein the first uplink signal is transmitted to the first TRP based on a sum of the first timing advance value and the second timing advance value; and receive a third timing advance command including the second timing advance offset identifier and the third timing advance value, wherein the third timing advance value includes a second timing advance offset value, and wherein the second uplink signal is transmitted to the second TRP based on a sum of the first timing advance value and the third timing advance value.

Aspect 9: The apparatus of aspect 7 or 8, wherein the bandwidth part configuration enables multi-TRP operation for the bandwidth part.

Aspect 10: The apparatus of any of aspects 7 through 9, wherein the bandwidth part is one of a plurality of bandwidth parts associated with the component carrier, and wherein the second timing advance information and the third timing advance information for the bandwidth part is not associated with one or more different bandwidth parts of the plurality of bandwidth parts.

Aspect 11: The apparatus of any of aspects 7 through 10, wherein the one or more different bandwidth parts of the plurality of bandwidth parts are configured for single TRP operation.

Aspect 12: An apparatus for wireless communication, comprising: a memory; and at least one processor coupled to the memory and configured to: transmit a configuration message including a serving cell configuration and a bandwidth part configuration, wherein the serving cell configuration includes first timing advance information for a component carrier, and wherein the bandwidth part configuration includes second timing advance information for a bandwidth part of the component carrier; transmit a first timing advance command including a first timing advance value associated with the first timing advance information; and transmit a second timing advance command including a second timing advance value associated with the second timing advance information.

Aspect 13: The apparatus of aspect 12, wherein the first timing advance information includes a first timing advance group identifier, the first timing advance command including the first timing advance group identifier, the second timing advance information includes a second timing advance group identifier, the second timing advance command including the second timing advance group identifier.

Aspect 14: The apparatus of aspect 12 or 13, wherein the bandwidth part configuration enables multi-TRP operation for the bandwidth part.

Aspect 15: The apparatus of any of aspects 12 through 14, wherein the bandwidth part is one of a plurality of bandwidth parts associated with the component carrier, and wherein the second timing advance information for the bandwidth part is not associated with one or more different bandwidth parts of the plurality of bandwidth parts.

Aspect 16: The apparatus of any of aspects 12 through 15, wherein the one or more different bandwidth parts of the plurality of bandwidth parts are configured for single TRP operation.

Aspect 17: The apparatus of any of aspects 12 and 14 through 16, wherein the first timing advance information includes a timing advance group identifier, the first timing advance command including the timing advance group identifier, and wherein the second timing advance information includes a timing advance offset identifier, the second timing advance command including the timing advance offset identifier.

Aspect 18: An apparatus for wireless communication, comprising: a memory; and at least one processor coupled to the memory and configured to: transmit a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier; transmit a first timing advance command including a first timing advance value associated with the first timing advance information; transmit a second timing advance command including a second timing advance value associated with the second timing advance information; and transmit a third timing advance command including a third timing advance value associated with the third timing advance information.

Aspect 19: The apparatus of aspect 18, wherein a timing advance group identifier is included in the first timing advance information and the first timing advance command, wherein a first timing advance offset identifier is included in the second timing advance information and the second timing advance command, and

wherein a second timing advance offset identifier is included in the third timing advance information and the third timing advance command.

Aspect 20: The apparatus of aspect 18 or 19, wherein the bandwidth part configuration enables multi-TRP operation for the bandwidth part.

Aspect 21: The apparatus of any of aspects 18 through 20, wherein the bandwidth part is one of a plurality of bandwidth parts associated with the component carrier, and wherein the second timing advance information and the third timing advance information for the bandwidth part is not associated with one or more different bandwidth parts of the plurality of bandwidth parts.

Aspect 22: The apparatus of any of aspects 18 through 21, wherein the one or more different bandwidth parts of the plurality of bandwidth parts are configured for single TRP operation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. The phrase “approximately equal” as used herein may mean equal to or within a range of +5%. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive a configuration message including a serving cell configuration and a bandwidth part configuration, wherein the serving cell configuration includes first timing advance information for a component carrier, and wherein the bandwidth part configuration includes second timing advance information for a bandwidth part of the component carrier;
transmit a first uplink signal to a first transmission reception point (TRP) using the bandwidth part based on at least a first timing advance value associated with the first timing advance information; and
transmit a second uplink signal to a second TRP using the bandwidth part based on at least a second timing advance value associated with the second timing advance information.

2. The apparatus of claim 1, wherein the first timing advance information includes a first timing advance group identifier and the second timing advance information includes a second timing advance group identifier, wherein the at least one processor is further configured to:
receive a first timing advance command including the first timing advance group identifier and the first timing advance value; and
receive a second timing advance command including the second timing advance group identifier and the second timing advance value.

3. The apparatus of claim 1, wherein the bandwidth part configuration enables multi-TRP operation for the bandwidth part.

4. The apparatus of claim 1, wherein the bandwidth part is one of a plurality of bandwidth parts associated with the component carrier, and wherein the second timing advance information for the bandwidth part is not associated with one or more different bandwidth parts of the plurality of bandwidth parts.

5. The apparatus of claim 4, wherein the one or more different bandwidth parts of the plurality of bandwidth parts are configured for single TRP operation.

6. The apparatus of claim 1, wherein the first timing advance information includes a timing advance group identifier and the second timing advance information includes a timing advance offset identifier, wherein the at least one processor is further configured to:
receive a first timing advance command including the timing advance group identifier and the first timing advance value; and
receive a second timing advance command including the timing advance offset identifier and the second timing advance value, wherein the second timing advance value includes a timing advance offset value, and wherein the second uplink signal is transmitted to the second TRP based on a sum of the first timing advance value and the second timing advance value.

7. An apparatus for wireless communication, comprising:
a memory; and
at least one processor coupled to the memory and configured to:
receive a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier;
transmit a first uplink signal to a first transmission reception point (TRP) using the bandwidth part based on a first timing advance value associated with the first timing advance information and a second timing advance value associated with the second timing advance information; and
transmit a second uplink signal to a second TRP using the bandwidth part based on the first timing advance value associated with the first timing advance information and a third timing advance value associated with the third timing advance information.

8. The apparatus of claim 7, wherein the first timing advance information includes a timing advance group identifier, the second timing advance information includes a first timing advance offset identifier, and the third timing advance information includes a second timing advance offset identifier, wherein the at least one processor is further configured to:
receive a first timing advance command including the timing advance group identifier and the first timing advance value;
receive a second timing advance command including the first timing advance offset identifier and the second timing advance value, wherein the second timing advance value includes a first timing advance offset value, and wherein the first uplink signal is transmitted to the first TRP based on a sum of the first timing advance value and the second timing advance value; and
receive a third timing advance command including the second timing advance offset identifier and the third timing advance value, wherein the third timing advance value includes a second timing advance offset value, and wherein the second uplink signal is transmitted to the second TRP based on a sum of the first timing advance value and the third timing advance value.

9. The apparatus of claim 8, wherein the bandwidth part configuration enables multi-TRP operation for the bandwidth part.

10. The apparatus of claim 7, wherein the bandwidth part is one of a plurality of bandwidth parts associated with the component carrier, and wherein the second timing advance information and the third timing advance information for the bandwidth part is not associated with one or more different bandwidth parts of the plurality of bandwidth parts.

11. The apparatus of claim 10, wherein the one or more different bandwidth parts of the plurality of bandwidth parts are configured for single TRP operation.

12. A method of wireless communication for a user equipment (UE), comprising:
receiving a configuration message including a serving cell configuration and a bandwidth part configuration, wherein the serving cell configuration includes first timing advance information for a component carrier, and wherein the bandwidth part configuration includes second timing advance information for a bandwidth part of the component carrier;
transmitting a first uplink signal to a first transmission reception point (TRP) using the bandwidth part based on at least a first timing advance value associated with the first timing advance information, and
transmitting a second uplink signal to a second TRP using the bandwidth part based on at least a second timing advance value associated with the second timing advance information.

13. The method of claim 12, wherein the first timing advance information includes a first timing advance group identifier and the second timing advance information includes a second timing advance group identifier, further comprising:
receiving a first timing advance command including the first timing advance group identifier and the first timing advance value; and
receiving a second timing advance command including the second timing advance group identifier and the second timing advance value.

14. The method of claim 12, wherein the bandwidth part configuration enables multi-TRP operation for the bandwidth part.

15. The method of claim 12, wherein the bandwidth part is one of a plurality of bandwidth parts associated with the component carrier, and wherein the second timing advance information for the bandwidth part is not associated with one or more different bandwidth parts of the plurality of bandwidth parts.

16. The method of claim 15, wherein the one or more different bandwidth parts of the plurality of bandwidth parts are configured for single TRP operation.

17. The method of claim 12, wherein the first timing advance information includes a timing advance group identifier and the second timing advance information includes a timing advance offset identifier, further comprising:
receiving a first timing advance command including the timing advance group identifier and the first timing advance value; and
receiving a second timing advance command including the timing advance offset identifier and the second timing advance value, wherein the second timing advance value includes a timing advance offset value, and wherein the second uplink signal is transmitted to the second TRP based on a sum of the first timing advance value and the second timing advance value.

18. A method of wireless communication for a user equipment (UE), comprising:
receiving a configuration message including a serving cell configuration and a bandwidth part configuration, wherein the serving cell configuration includes first timing advance information for a component carrier, and wherein the bandwidth part configuration includes second timing advance information and third timing advance information for a bandwidth part of the component carrier;
transmitting a first uplink signal to a first transmission reception point (TRP) using the bandwidth part based on a first timing advance value associated with the first timing advance information and a second timing advance value associated with the second timing advance information; and
transmitting a second uplink signal to a second TRP using the bandwidth part based on the first timing advance value associated with the first timing advance information and a third timing advance value associated with the third timing advance information.

19. The method of claim 18, wherein the first timing advance information includes a timing advance group identifier, the second timing advance information includes a first timing advance offset identifier, and the third timing advance information includes a second timing advance offset identifier, wherein the at least one processor is further configured to:
receiving a first timing advance command including the timing advance group identifier and the first timing advance value;
receiving a second timing advance command including the first timing advance offset identifier and the second timing advance value, wherein the second timing advance value includes a first timing advance offset value, and wherein the first uplink signal is transmitted to the first TRP based on a sum of the first timing advance value and the second timing advance value; and
receiving a third timing advance command including the second timing advance offset identifier and the third timing advance value, wherein the third timing advance value includes a second timing advance offset value, and wherein the second uplink signal is transmitted to the second TRP based on a sum of the first timing advance value and the third timing advance value.

20. The method of claim 18, wherein the bandwidth part configuration enables multi-TRP operation for the bandwidth part.

21. The method of claim 18, wherein the bandwidth part is one of a plurality of bandwidth parts associated with the component carrier, and wherein the second timing advance information for the bandwidth part is not associated with one or more different bandwidth parts of the plurality of bandwidth parts.

22. The method of claim 21, wherein the one or more different bandwidth parts of the plurality of bandwidth parts are configured for single TRP operation.
